(19) United States
(12) Patent Application Publication
(10) Pub. No.: US 2016/0188173 A1
(43) Pub. Date: Jun. 30, 2016

(54) Replicating User Input Across Displayed Search Results

(71) Applicant: Quixey, Inc., Mountain View, CA (US)

(72) Inventors: Eric J. Glover, Palo Alto, CA (US); James Delli Santi, San Jose, CA (US)

(73) Assignee: Quixey, Inc., Mountain View, CA (US)

(21) Appl. No.: 14/972,534

(22) Filed: Dec. 17, 2015

Related U.S. Application Data
(60) Provisional application No. 62/098,805, filed on Dec. 31, 2014.

(51) Int. Cl. G06F 3/0484; G06F 17/30; G06F 17/24

(52) U.S. Cl. CPC G06F 3/04842; G06F 17/243; G06F 17/30864

(57) ABSTRACT

A method includes transmitting a search query to a search engine and receiving search results that include a first result object corresponding to a first displayed search result and a second result object corresponding to a second displayed search result. The first displayed search result corresponds to a first software application and includes one or more first input elements. The second displayed search result corresponds to a second software application and includes one or more second input elements. The method includes receiving user input in at least one of the one or more the first input elements and replicating the user input in at least one of the one or more second input elements. The method also includes receiving a selection of the second displayed search result, determining an access mechanism to access a state of the second software application, and launching an edition of the software application.

### CROSS REFERENCE TO RELATED APPLICATIONS

This application claims priority under 35 U.S.C. §119(e) to U.S. Provisional Patent Application No. 62/098,805, filed on Dec. 31, 2014, which is hereby incorporated by reference in its entirety.

### TECHNICAL FIELD

This disclosure relates to replicating user input across displayed search results.

### BACKGROUND

Search engines can be utilized in many different fields. Search engines can be used to identify content on the World Wide Web (the “Web”), identify applications, or identify functionalities across the Web and a collection of applications. When a search engine receives a search query it provides search results which link to resources. The user can click on a search result to access a resource. For example, the user can click on a search result to access a web page indicated by the search results.

### SUMMARY

According to some implementations of the present disclosure, a method for replicating user input across search results is disclosed. The method includes transmitting a search query to a search engine and receiving search results in response to the search query. The search results include a first result object corresponding to a first displayed search result and a second result object corresponding to a second displayed search result. The first displayed search result corresponds to a first software application and the second displayed search result corresponds to a second software application. The method further includes generating the first displayed search result based on the first result object. The first displayed search result is displayed in a graphical user interface via a user interface of the user device and including one or more first input elements that receive user input. The method also includes generating the second displayed search result based on the second result object. The second displayed search result is also displayed in the graphical user interface via the user interface of the user device and includes one or more second input elements that receive user input. The method optionally further includes receiving user input in at least one of the one or more the first input elements via the user interface and replicating the user input in at least one of the one or more second input elements. The method optionally also includes receiving a selection of the second displayed search result by the user via the user interface, determining an access mechanism to access a state of the second software application indicated by the second displayed search result based on the replicated user input, and launching an edition of the software application using the access mechanism.

According to some implementations, replicating the user input includes determining that the first displayed search result is functionally similar to the second displayed search result. Replicating the user input may also include, for each of the at least one first input elements that received user input, identifying whether the second displayed search result includes a corresponding second input element that receives the same parameter type as the first input elements. When the second displayed search result includes the corresponding second input element, the replicating the user input includes: reading user input from the first input element; and inserting the read user input into the corresponding second input element. Further, according to some implementations, determining the first displayed search result is functionally similar to the second displayed search result includes determining a first function of the first software application implicated by the first displayed search result, determining a second function of the second software application implicated by the second search result, and determining that the first displayed search result and the second displayed search result are functionally similar when the first function and the second function match.

According to some implementations the access mechanism is an application access mechanism. In these implementations, launching the edition of the second software application includes launching a native application edition of the second software application and setting the state of the native application edition to the state indicated by the application access mechanism. Furthermore, determining the access mechanism can include transmitting a request to the search engine for the access mechanism, the request including the replicated input and receiving the access mechanism from the search engine. Additionally or alternatively, determining the access mechanism can include generating the access mechanism based on a template contained in the second result object and the replicated input.

In some scenarios, the method may further include generating a third displayed search result based on a third result object contained in the search results. The third displayed search result is displayed in the graphical user interface via the user interface and including one or more third input elements that receive user input. In these scenarios, the method may further include determining whether the third displayed search result is functionally similar to the first displayed search result, and replicating the user input in at least one of the one or more third input elements when the third displayed search result is functionally similar to the first displayed search result.

According to some implementations, replicating the user input includes receiving a user selection of a replicate selection element displayed in the graphical user interface. Replicating the user input is performed in response to the selection of the replicate selection element. In other implementations, replicating the user input is performed automatically in response to determining the first displayed search result and the second displayed search result are functionally similar and receiving the user input. According to some implementations, replicating the user input includes transmitting a request to the search engine including at least one value and at least one respective parameter types corresponding to the at least one first input elements that received the at least one value. In these implementations, replicating the user input further includes receiving an instruction from the search engine indicating the at least one second input element and at least one respective value to input in the at least one second input element. Replicating the user input, according to these implementations, also includes inserting the at least one value in the respective at least one second input element.

According to some implementations of the present disclosure, a user device is disclosed. The user device includes a user interface, a storage device, a network interface device, and a processing device. The processing device executing computer-readable instructions that when executed cause the processing device to transmit a search query to a search engine and receive search results in response to the search query. The search results include a first result object corresponding to a first displayed search result and a second result object corresponding to a second displayed search result. The first displayed search result corresponds to a first software application and the second displayed search result corresponds to a second software application. The computer readable instructions further cause the processing device to generate the first displayed search result based on the first result object and generate the second displayed search result based on the second result object. The first displayed search result and the second displayed search result are displayed in a graphical user interface via the user interface and respectively include one or more first input elements and one or more second input elements that receive user input. The computer readable instructions further cause the processing device to receive user input in at least one of the one or more the first input elements via the user interface and replicate the user input in at least one of the one or more second input elements. The computer readable instructions further cause the processing device to receive a selection of the second displayed search result by the user via the user interface, determine an access mechanism to access a state of the second software application indicated by the second displayed search result based on the replicated user input, and launch an edition of the software application using the access mechanism.

According to some implementations, replicating the user input includes determining that the first displayed search result is functionally similar to the second displayed search result. Replicating the user input may also include, for each of the at least one first input elements that received user input, identifying whether the second displayed search result includes a corresponding second input element that receives the same parameter type as the first input elements. When the second displayed search result includes the corresponding second input element, the replicating the user input includes: reading user input from the first input element; and inserting the read user input into the corresponding second input element. Further, according to some implementations, determining the first displayed search result is functionally similar to the second displayed search result includes determining a first function of the first software application implicated by the first displayed search result, determining a second function of the second software application implicated by the second search result, and determining that the first displayed search result and the second displayed search result are functionally similar when the first function and the second function match.

According to some implementations the access mechanism is an application access mechanism. In these implementations, launching the edition of the second software application includes launching a native application edition of the second software application and setting the state of the native application edition to the state indicated by the application access mechanism. Furthermore, determining the access mechanism can include transmitting a request to the search engine for the access mechanism, the request including the replicated input and receiving the access mechanism from the search engine. Additionally or alternatively, determining the access mechanism can include generating the access mechanism based on a template contained in the second result object and the replicated input.

In some scenarios, the computer readable instructions may cause the processing device to generate a third displayed search result based on a third result object contained in the search results. The third displayed search result is displayed in the graphical user interface via the user interface and including one or more third input elements that receive user input. In these scenarios, the computer-readable instructions may further cause the processing device to determine whether the third displayed search result is functionally similar to the first displayed search result, and replicating the user input in at least one of the one or more third input elements when the third displayed search result is functionally similar to the first displayed search result.

According to some implementations, replicating the user input includes receiving a user selection of a replicate selection element displayed in the graphical user interface. Replicating the user input is performed in response to the selection of the replicate selection element. In other implementations, replicating the user input is performed automatically in response to determining the first displayed search result and the second displayed search result are functionally similar and receiving the user input. According to some implementations, replicating the user input includes transmitting a request to the search engine including at least one value and at least one respective parameter types corresponding to the at least one first input elements that received the at least one value. In these implementations, replicating the user input further includes receiving an instruction from the search engine indicating the at least one second input element and at least one respective value to input in the at least one second input element. Replicating the user input, according to these implementations, also includes inserting the at least one value in the respective at least one second input element.

According to some implementations of the present disclosure, a method is disclosed. The method includes receiving a search query from a user device and generating search results based on the search query. The search results include a first result object corresponding to a first displayed search result and a second result object corresponding to a second displayed search result. The first displayed search result corresponds to a first software application and, when rendered by the user device, includes one or more first input elements that receive user input. The second displayed search result corresponds to a second software application and, when rendered by the user device, includes one or more second input elements that receive user input. The method further includes receiving a request from the user device indicating at least one input value input into at least one of the first input elements of the first displayed search result. The method further includes determining an instruction based on the input data, the instruction indicating at least one replicated value to input into at least one of the second input elements of the second displayed search result based on the at least one input value. The method also includes transmitting the instruction to the user device, whereby the user device inserts the at least one replicated value in at least one of the second input elements.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view illustrating an example environment of a search engine that receives search queries from user devices.

FIG. 1B is a schematic view illustrating an example user device in communication with a search engine.

FIG. 1C a schematic view illustrating an example of a user device displaying search results including a displayed search results that receives user input.

FIG. 1D a schematic view illustrating an example of a user device executing a native application in response to selection of the displayed search result of FIG. 1C.

FIG. 1E a schematic view illustrating an example of a user device displaying search results including a displayed search result that receives user input.

FIG. 1F a schematic view illustrating an example of a user device executing a native application in response to selection of the displayed search result of FIG. 1E.

FIG. 2A is a schematic view illustrating example components of a search engine.

FIG. 2B is a schematic view illustrating example components of a search engine and data flow thereof.

FIGS. 2C and 2D are schematic views illustrating example components of a function record and a result object record, respectively.

FIG. 2E is a schematic view illustrating example components of a search module of the search engine and a data flow thereof.

FIG. 2F is a schematic view illustrating example data flow of the results processing module.

FIG. 3 is a schematic view illustrating example components of a user device.

FIG. 4 is a flow chart illustrating an example set of operations of a method for processing a search query.

FIG. 5 is a flow chart illustrating an example set of operations of a method for performing a search on a user device.

FIG. 6 is a flow chart illustrating an example set of operations of a method for responding to a user selection of a resize element.

FIGS. 7A-7C are schematic views illustrating an example of a user input being replicated across displayed search result.

FIG. 8 is a flow chart illustrating an example set of operations of replicating user input across a set of displayed search results.

Like reference symbols in the various drawings indicate like elements.

### DETAILED DESCRIPTION

The present disclosure relates to a search system that delivers search results that is include user selectable links that receive user input. Furthermore, according to some implementations of the present disclosure the user selectable links (also referred to as “displayed search results) may be configured to replicate user input across other user selectable links. For instance, a first user selectable link may correspond to a first software application and may allow a user to input one or more parameter values into the first user selectable link. The user may enter the parameter values into the user selectable link. In response to selecting the user selectable link, the user device may access a state of a first software application that corresponds to the inputted parameters. For example, if the first software application allows users to make travel reservations and the user enters specific airport codes and dates, the user device may access a state of the software application where the user can purchase a plane ticket traveling between the two airport codes on the indicated dates. Additionally, the user may opt to replicate the parameter values across other displayed search results. For example, if a second user selectable link accepts the same types of parameters (e.g., airport codes and dates), the user can instruct the user device to replicate the parameter values to the second user selectable link. In this way, the user does not need to reenter the parameter values into the second user selectable link.

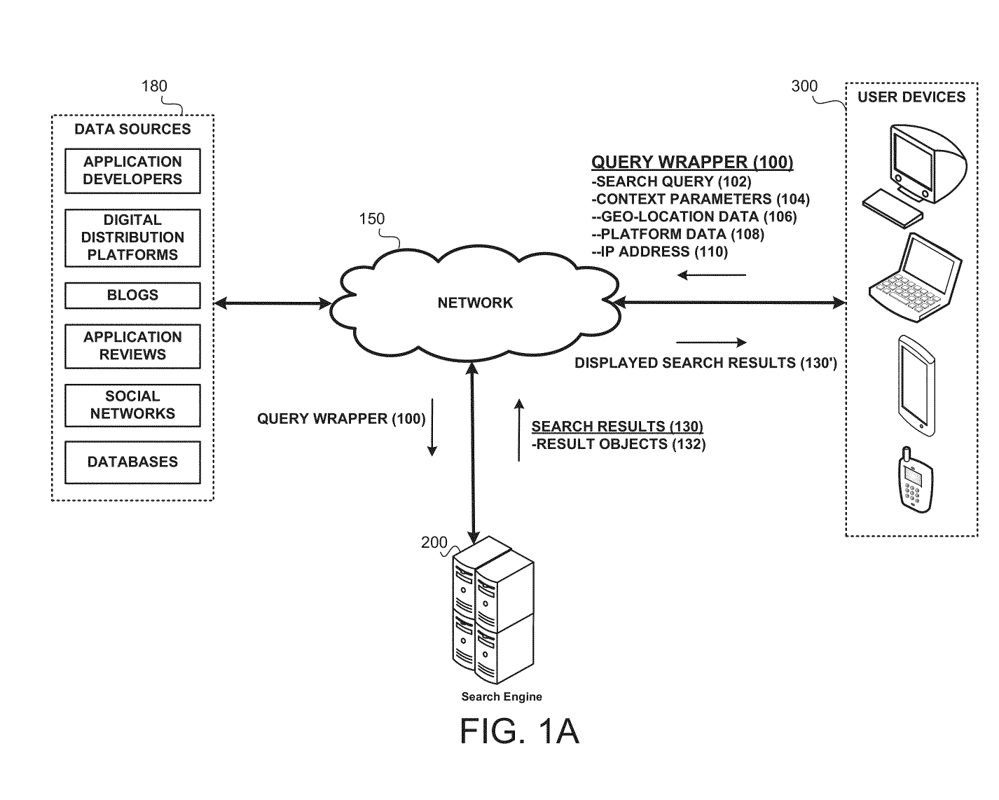

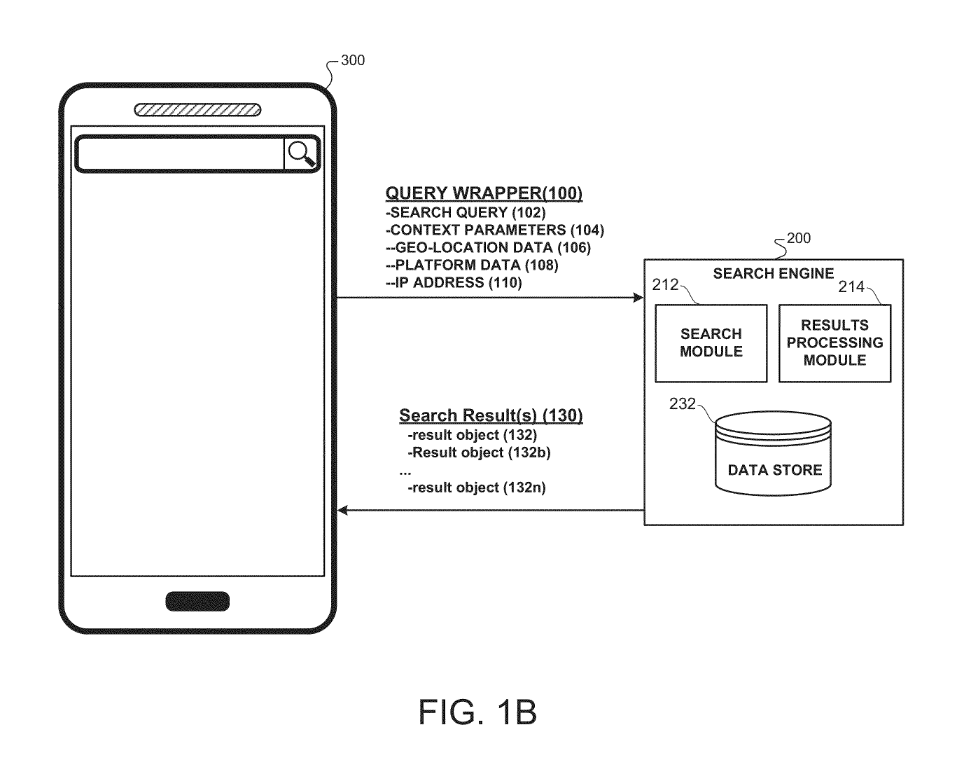

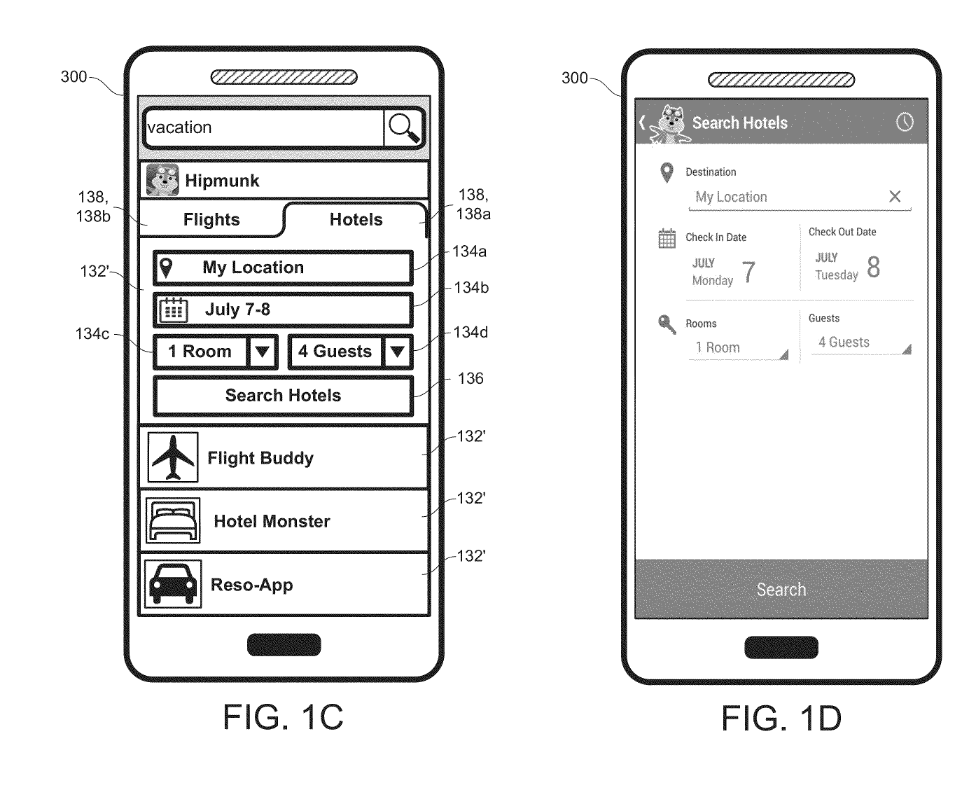

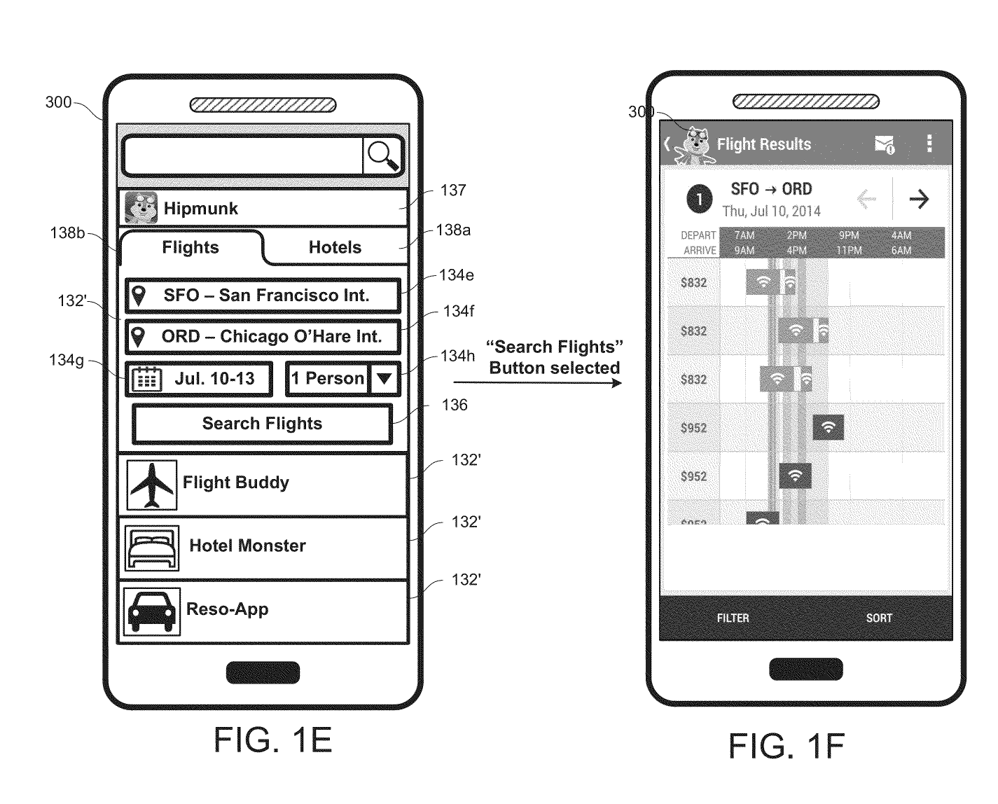

FIG. 1A illustrates an example environment 10 of a search engine 200. A search engine 200 is a collection of one or more computing devices that receives search queries 102 from user devices 300 via a network 150. A user device 300 can be any suitable user computing device including, but not limited to, a smartphone, a tablet computing device, a personal computing device, a laptop computing device, a gaming device, a vehicle infotainment device, and/or a smart appliance (e.g., smart refrigerator or smart television).

The search engine 200 may perform any suitable type of searches. For example, the search engine 200 may perform web searches (e.g., for content found on websites), application searches (e.g., for applications having particular attributes), and/or function searches (e.g., for specific states or functions of either native or web applications). For purposes of explanation, reference is made to a search engine 200 that performs function searches, whereby the search engine 200 identifies states or functions of applications that are relevant to the search query 102. The search engine 200 may perform other types of searches, while performing the function searches and the search results 130 may indicate the results of the other searches as well.

An application can refer to a software product that, when executed by a computing device, causes the computing device to perform a function. In some examples, an application may also be referred to as an “app” or a “program.” Example applications include, but are not limited to, productivity applications, social media applications, messaging applications, media streaming applications, social networking applications, and games. Applications can perform a variety of different functions for a user. For example, a restaurant reservation application can make reservations for restaurants. As another example, an internet media player application can stream media (e.g., a song or movie) from the Internet. In some examples, a single application can provide more than one function. For example, a restaurant reservation application may also allow a user to retrieve information about a restaurant and read user reviews for the restaurant in addition to making reservations. As another example, an Internet media player application may also allow a user to perform searches for digital media, purchase digital media, generate media playlists, and share media playlists. Applications can include native applications and web-based applications.

A native application is an application that is, at least in part, installed on a user device 300. In some scenarios, a native application is installed on a user device 300, but accesses an external resource (e.g., an application server) to obtain data from the external resource. For example, social media applications, weather applications, news applications, and search applications may respectively include one or more native application versions that execute on various user devices 300. In such examples, a native application can provide data to and/or receive data from the external resource while performing one or more functions of the application. In other scenarios, a native application is installed on the user device 300 and does not access any external resources. For example, some gaming applications, calendar applications, media player applications, and document viewing applications may not require a connection to a network to perform a particular function.

A web-based application (also referred to herein as a web application) may be partially executed by a user device 300 (e.g., by a web browser executed by the user device 300) and partially executed by a remote computing device (e.g., a web server or application server). For example, a web application may be an application that is executed, at least in part, by a web server and accessed by a web browser (e.g., a native application) of the user device 300. Example web applications may include, but are not limited to, web-based email, online auctions websites, social-networking websites, travel-booking websites, and online retail websites.

In some scenarios, an application includes one or more native application editions of the application and a web application edition of the application. In these scenarios, there may be overlap between the states or functions that the native application edition(s) can access and the states or functions that the web application edition can access. For example, a restaurant review application may have reviews of thousands of restaurants and may also provide an on-line ordering function from some of the restaurants. The restaurant review application may have a first native application edition configured for a first operating system (e.g., the ANDROID operating system maintained by Google, Inc.), a second native application edition configured for a second operating system (e.g., the IOS operating system developed by Apple, Inc.), and a web application edition accessible using a web browser. The restaurant review application may allow all the editions (native and web) to access the various reviews of restaurants but may only allow on-line orders to be placed using the native application editions. In this way, some states or functions of the restaurant review application cannot be accessed by the web application edition, but there is overlap between the states or functions that can be accessed by the native application editions and the web application edition.

In general, the user device 300 may communicate with the search engine 200 using any application that can transmit search queries 102 to the search engine 200. In some examples, the user device 300 runs a native application that is dedicated to interfacing with the search engine 200 (e.g., a search application 312). In some examples, the user device 300 communicates with the search engine 200 using a more general application, such as a web application accessed using a web browser native application. Although the user device 300 may communicate with the search engine 200 using the native search application 312 and/or a web-browser application, the user device 300 may be described hereinafter as using the native search application 312 to communicate with the search engine 200. In some implementations, the functionality attributed to the search application 312 may be included as a searching component of a larger application that has additional functionality. For example, the functionality attributed to the search application 312 may be included as part of a native application or a web application as a feature of another application that provides search capabilities.

A user device 300 transmits a search query 102 to the search engine 200, which processes the search query 102 and generates search results 130 based thereon. A search query 102 can refer to a set of one or more query terms. A query term is a string of one or more characters (e.g., letters, number, and/or symbols). In some implementations, the user device 300 transmits the search query 102 in a query wrapper 100. A query wrapper 100 is a transmittable data structure that stores the search query 102. The query wrapper 100 can contain additional information, which may be referred to as context parameters 104. Examples of context parameters 104 include geolocation data 106 that indicates a geolocation of the user device 300 at a particular time, platform data 108 that indicates an operating system type of the user device 300, an IP address 110 that indicates an IP address of the user device 300, and any other suitable data (e.g., a username of a user associated with the user device 300).

The search engine 200 generates search results 130 based on a search query 102 (and in some cases one or more context parameters 104) and provides the search results 130 to a requesting user device 300. According to some implementations, the search engine 200 identifies one or more states or functions of one or more respective applications that are relevant to the search query 102. For instance, in response to the search query 102 “call a cab,” the search engine 200 identifies various states or functions of applications that can help a user make a taxi reservation.

The search engine 200 generates search results 130 that are indicative of the identified states or functions. The user device 300 renders the search results 130 into displayed search results 130′. The search results 130 can include one or more result objects 132. In some implementations, each result object 132 represents a single search result 132. A result object 132 can include an encoded search result, which can define search result data (e.g., text, images, and instructions). In some implementations, a result object includes data and instructions, which the user device 300 utilizes to render the displayed search result 132′. The data and instructions may define the layout of displayed search result 132′ as well as the look and feel of the displayed search result (e.g., fonts, font sizes, styles, colors, etc.). The user device 300 renders a displayed search result 132′ using the search result data defined by the encoded search result. For purposes of explanation, reference to a “search result” can include reference to an encoded search result or a displayed search result 132′. Put another way, before a search result has been rendered, the term “search result” references an encoded search result, and after rendering references a displayed search result resulting from the encoded search result.

A result object 132 can include any suitable search result data. For example, a result object 132 can include display data, access mechanism data, GUI data, instructions, referential data, a result score, and layout data. A result object 132 may include any combination of the above-identified data, as well as additional or alternative data. The individual types of data that may be found in a result object 132 are described in greater detail below.

A displayed search result 132′ can link a user to a state of an application. In these implementations, the displayed search results 130′ are a collection of user selectable links, whereby the user selectable links link the user to one of a plurality of applications or a state (or function) thereof that are relevant to the search query 102. A user selectable link can include one or more access mechanisms. Examples of access mechanisms include, but are not limited to, native application access mechanisms (hereinafter “application access mechanism”), web access mechanisms, application download access mechanisms, and/or scripts. A user device 300 uses an access mechanism to access functionality of an application. An access mechanism can provide access to a default page of an application (e.g., a home page) or a deeper state of the application.

An application access mechanism may be a string that includes a reference to a native application (e.g., one of native applications) and indicates one or more operations for the user device 300 to perform. If a user selects a user selectable link 144 including an application access mechanism, the user device 300 may launch the native application referenced in the application access mechanism and perform the one or more operations indicated in the application access mechanism. In some implementations, any combination of the operating system of the user device 300, a search application executed by the user device 300, a native application executed by the user device 300, and/or a web browser executed by the user device 300 can launch the native application referenced in the application access mechanism A web access mechanism may include a resource identifier that includes a reference to a web resource (e.g., a page of a web application/website). For example, a web access mechanism may refer to a uniform resource locator (URL) (i.e., a web address) used with hypertext transfer protocol (HTTP). If a user selects a user selectable link including a web access mechanism, the user device 300 may launch the web browser application and retrieve the web resource indicated in the resource identifier. An application download access mechanism may indicate a location (e.g., a digital distribution platform) where a native application can be downloaded in the scenario where a native application edition of the application is not installed on the user device 300. If a user selects a user selectable link 144 including an application download access mechanism, the user device 300 may access a digital distribution platform from which the referenced native application edition may be downloaded. A script is a set of instructions, that when executed by the user device 300 causes the user device to access a resource indicated by the script. For example, the script may instruct an operating system of the user device 300 to launch the native application, and may define one or more additional instructions to access a particular state of the application. A script may be used instead of another type of access mechanism when an application is not configured to be referenced by the other types of access mechanisms.

In some scenarios, the search results 130 include result objects 132 that define one or more input elements. An input element can refer to a GUI element that receives input from a user via the user interface of the user device 300, whereby the value entered into an input element maps to one of a set of input parameters. When the user device 300 renders and displays a displayed search result 132′, the displayed search result 132′ can receive and display the value in an area of the displayed result 132′ defined by the input element. Examples of input elements can include, but are not limited to, text input element, drop-down menus, calendar input elements, radio button input elements, and slider input elements. When the user enters one or more values into respective input elements of a displayed search result 132′ and selects the displayed search result 132′ (e.g., presses an execution element), the user device 300 accesses a state of an application indicated by the search result that is based on the one or more values. In this way, the displayed search result 132′ is a user selectable link that receives input from a user. In some implementations, the user device 300 utilizes an access mechanism that is indicative of the one or more values to access the state of the application indicated by the displayed search result 132′. The user device 300 can receive, request, and/or generate the access mechanism, examples of which are displayed in greater detail below.

FIG. 1C illustrates an example of displayed search results 132′. In some scenarios, the search engine 200 responds to a search query 102 with search results 130, that when rendered by the user device 300, include one or more displayed search results 132′ that include one or more input elements 134. In the illustrated example, the displayed search results 132′ are in response to the search query 102 “vacation.” The displayed search results 132′ include a displayed search result 132a′ that allows the user to access a hotel booking functionality of the HIPMUNK application by Hipmunk, Inc., as indicated by the hotel tab 138a. In this example, the example displayed search result 132a′ includes a text input element 134a that allows the user to enter a location, a calendar input element 134b that allows the user to enter check-in and check-out dates, a first drop-down menu input element 134c that allows the user to select a number of rooms, and a second drop-down menu input element 134d that allows the user to select a number of guests. The user can input various values into the respective input elements and select (e.g., press upon) a selection box 136, thereby selecting the displayed search result 132a′.

In response to the user selection of the displayed search result 132a′, the user device 300 launches the HIPMUNK application and provides the values inputted into the input elements to the HIPMUNK application. As will be discussed, the user device 300 can provide the values to an application in a number of different manners. For example, the user device 300 can generate and utilize an access mechanism that is based on the values entered into the displayed search result 132a′ to access a state of the HIPMUNK application that is based on the inputted values. Additionally or alternatively, the user device 300 can launch a native application edition (or a web-application edition) of the HIPMUNK application and can enter the values inputted by the user into a graphical user interface displayed by the native application. In FIG. 1D, the user device 300 has launched, and is executing, the HIPMUNK application in response to the user selecting the displayed search result 132a′ displayed in FIG. 1C. In this example, the user device 300 enters the values provided by the user into the displayed search result 132a of FIG. 1C into the graphical user interface of the HIPMUNK native application. In this way, selection of the displayed search result 132a allows the user to access the hotel reservation function of the HIPMUNK application.

In some scenarios, a displayed search result 132′ can link to multiple functionalities of an application. FIG. 1E (and FIG. 1C) illustrates an example of a displayed search result 132a′ that can link to multiple functionalities of an application. In this example, the user has selected a flight tab 138b to link to the flight reservation function of the HIPMUNK application instead of the hotel reservation function of the HIPMUNK application. In the illustrated example, the flight tab includes first and second input elements 134e, 134f that respectively allow a user to enter a departure airport and an arrival airport. The flight tab 138b of the displayed search result 132a further includes a calendar input element 134g that allows a user to enter departure and return dates, as well as a drop down menu 134h that allows the user to enter a number of travelers. The user can access the flight reservation functionality of the HIPMUNK application by selecting the “search flights” selection element 136.

In FIG. 1F, the user device 300 has launched the native application edition of the HIPMUNK application and has accessed a state of the HIMPUNK application that displays available flight options given the values input by the user into the displayed search result 132a′. In this example, the user device 300 may have utilized an application access mechanism that is based on the inputted values to access the state of the HIPMUNK application. In this way, the user device 300 is able to directly access this state from the search engine results page (hereafter “SERP”) based on the values entered into the input elements 134 of the displayed search result 132′. The user device 300 may obtain the application access mechanism in a number of different manners. For example, the user device 300 may request the application access mechanism from the search engine 200 upon user selection of the selection element 136 or may generate the application access mechanism based on the inputted values. In another example, the user device 300 may utilize a set of instructions for generating access mechanisms for a particular application given a set of parameter types. In other implementations, the user device 300 can behave in a manner similar to the examples of FIGS. 1C and 1D, whereby the user device 300 launches the application and inputs the parameters into a GUI of the native application.

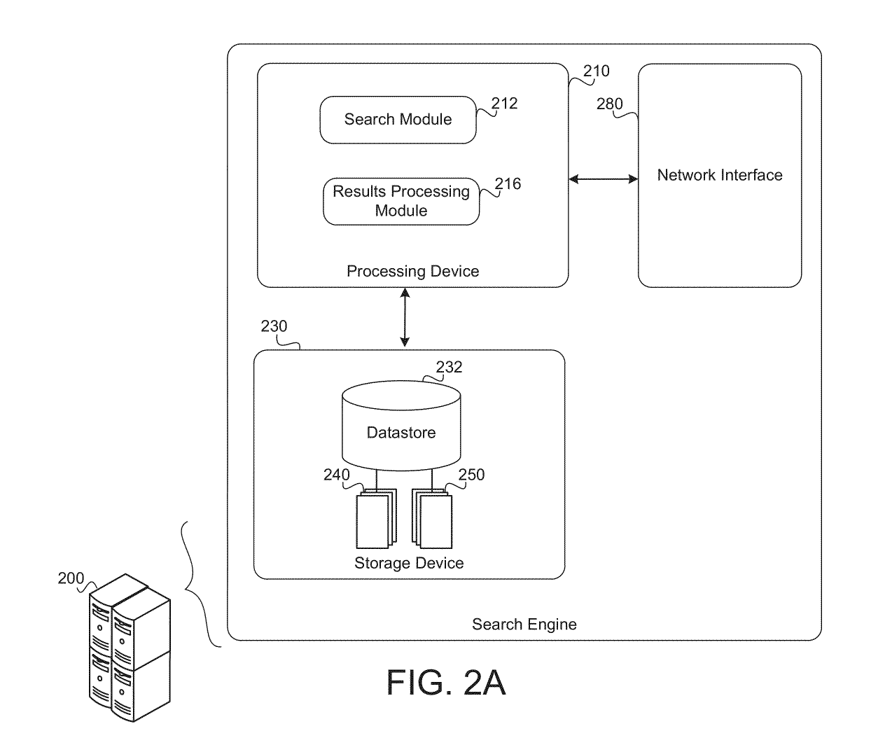

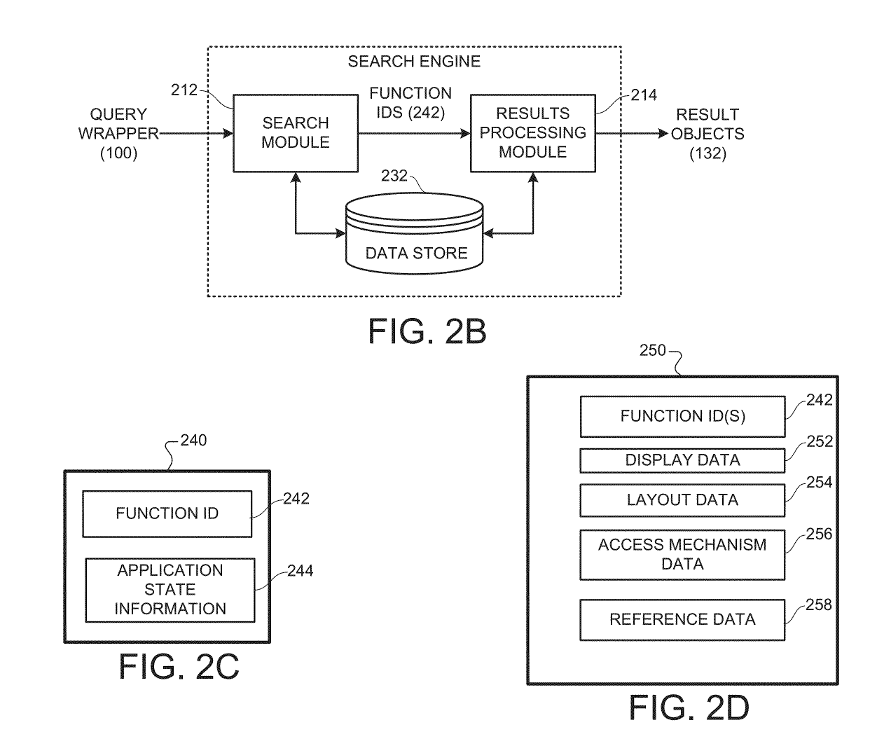

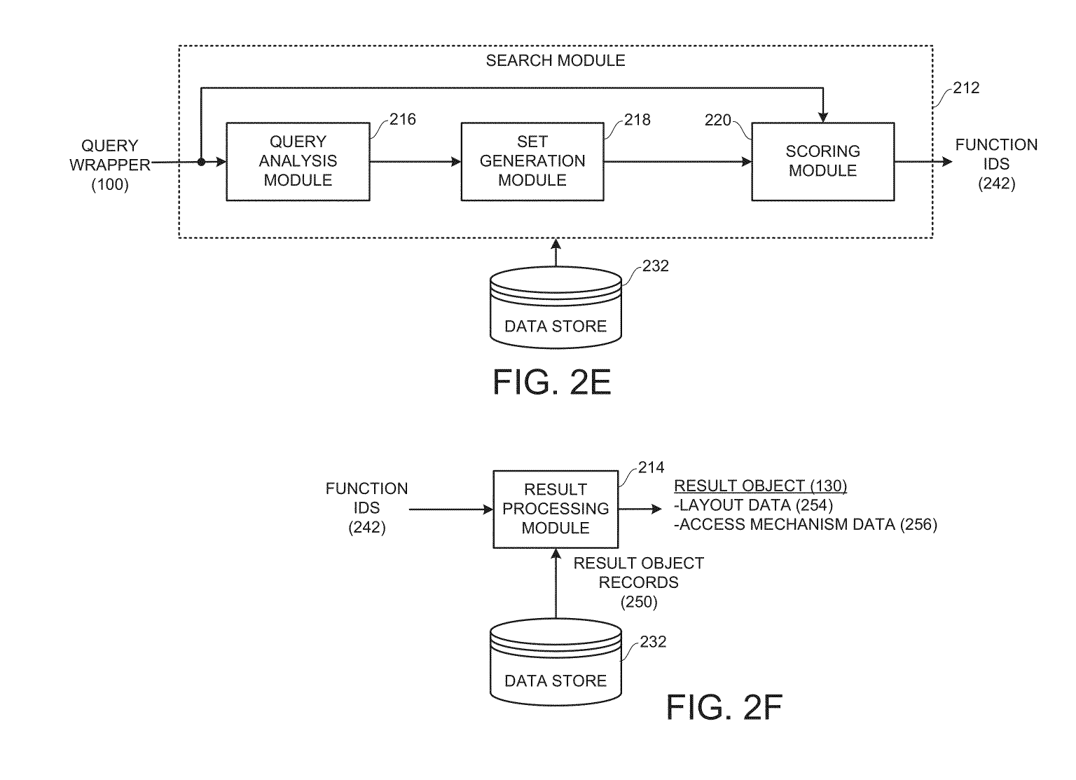

FIGS. 2A-2F illustrate an example search engine 200 and data flows thereof. In the illustrated example of FIG. 2A, the search engine 200 includes, but is not limited to a processing system 210, a storage system 230, and a network interface device 280. In some implementations, the search engine 200 may be incorporated in a larger search system (not shown) that includes an advertising engine and/or other engines. For purposes of discussion, the search engine 200 is described as performing functional searches. Although the techniques described herein may be applied to other suitable searches.

The processing system 210 can include memory (e.g., RAM and/or ROM) that stores computer executable instructions and one or more processors that execute the computer executable instructions. In implementations of two or more processors, the processors can operate in an individual or distributed manner. In these implementations, the processors can be arranged in a single computing device or across multiple computing devices (e.g., rack-mounted servers). The processing system 210 can execute a search module 212 and a results processing module 214.

The network interface device 280 includes one or more devices that can perform wired or wireless (e.g., Wi-Fi or cellular) communication. Examples of the network interface device 280 include, but are not limited to, a transceiver configured to perform communications using the IEEE 802.11 wireless standard, an Ethernet port, a wireless transmitter, and a universal serial bus (USB) port.

The storage system 230 can include one or more computer-readable storage mediums (e.g., hard disk drives and/or flash memory drives). The storage mediums can be located at the same physical location or at different physical locations (e.g., different servers and/or different data centers). In the illustrated example, the storage system 230 stores a data store 232. The data store 232 may include one or more databases, indices (e.g., inverted indices), tables, files, or other data structures which may be used to implement the techniques of the present disclosure. The data store stores function records 240 and result object records 250. While reference is made to a single data store 232, the function records 240 and result object records 250 may be stored in separate data stores 232. The storage system 230 may store any other suitable data stores.

FIG. 2B illustrates an example data flow of the search engine 200 according to some implementations of the present disclosure. In the illustrated example, the search module 212 receives a query wrapper 100 that contains a search query 102. The search module 212 searches the function records 240 stored in the data store 232 to identify a set of function records 240 that are relevant to the search query 102. The search module 212 scores the function records 240, and outputs a set of scored function identifiers 242 to the results processing module 214. The scored function IDs 242 respectively represent the scored function records 240. Additionally or alternatively, the search module 212 can be configured to output actual function records 240.

FIG. 2C illustrates an example of a function record 240. Each function record 240 may include data related to a function of an application and/or the state of the application resulting from performance of the function. A function record 240 may include a function identifier 242 (referred to as a “function ID”) and application state information 244. The function records 240 can contain additional types of data not explicitly discussed without departing from the score of the disclosure.

A function ID 242 can identify a function record 240 among the other function records 240 included in the function record data store 232. The function ID 242 may be a string of alphabetic, numeric, and/or symbolic characters. In some examples, the function ID 242 may describe a function and/or an application state in human readable form. For example, the function ID 242 may include the name of the application referenced in the function record 240. Additionally, or alternatively, the function ID 242 may be a human readable string that describes a function performed by the function or state corresponding to the function record 240. In some examples, the function ID 242 may include a string in the format of or similar to a uniform resource locator (URL) of a web access mechanism. For example, the function ID 242 may be a web URL or a URL-like structure that references a different namespace (e.g., “func://” instead of “http://”). In some implementations, a function ID 242 may take the form of a parameterizable function. For instance, a function ID 242 may be in the form of “app_id[action(param_1, param_2, . . . , parameter_n)]”, where app_id is an identifier (e.g., name) of a software application, action is an action that is performed by the application (e.g., “view menu”), and parameter_1 . . . parameter_n are n parameters that the software application receives in order to access the state corresponding to the action and the parameters. Drawing from the example above, a function ID 242 may be “exampleapp[example_action(abc, xyz)]”. In this example, the function ID 242 can be said to be parameterized, whereby the value of “param1” is set to “abc” and the value of “param2” is set equal to “xyz.” Given this function ID 242 and the referencing schema of the example application, the foregoing function ID 242 may be used to generate or look up the access mechanisms defined above. The function ID 242 may also be used to generate a function tag, which can be used to indicate a function of the application that can be accessed from a displayed search result 132′ that is generated based on the record 240 referenced by the function ID 242. While function IDs 242 have been described with respect to resource identifiers, a function ID 242 may be used to generate or look up one or more scripts that access a state of a software application. Further, a function ID 242 may take any other suitable format.

In an example where the function ID 242 includes a string in the format of a URL, the function ID 242 may include the following string “http://www.xyz.com/biz/the-french-connection-2?ob=1” to uniquely identify the function record 240. In other examples, the function ID 242 may include a URL using a namespace other than “http://,” such as “func://,” which may indicate that the URL is being used as a function ID 242 in a function record 240 (e.g., “func://xyz.com/biz/the-french-connection-2?ob=1”).

The application state information 244 may include data that describes features of a state or functionality to which the function record 240 corresponds. The application state information 244 may include a variety of different types of data. The application state information 244 may include structured, semi-structured, and/or unstructured data. In some implementations, the search engine 200 may extract and/or infer the application state information 244 from documents retrieved from various data sources. For example, the search engine 200 may crawl various data sources 180 (FIG. 1A) such as digital distribution platforms, websites of application developers, reviews of applications, the applications themselves (native applications and/or web applications), and any other suitable data sources 180 to obtain the application state information 244. Additionally or alternatively, the application state information 244 may be human curated. In some examples, the application state information 244 may include data that an application presents to a user when the application is set to an application state defined by an access mechanism. For example, if the function record 240 is associated with a shopping application, the application state information 244 may include data that describes a product (e.g., product name, product seller, product description, and prices) that are shown when the shopping application is set to a particular state application state. As another example, if the function record 240 is associated with a music player application, the application state information 244 may include data that describes a song (e.g., name of the song, album of the song, artist, reviews of the song, etc.) that is played when the music player application is set to a particular application state. Furthermore, the application state information 244 may include information that describes the application itself. For example, the application state information 244 may include a name of the application, a developer of the application, and the platforms for which the application is developed (e.g., web-based, IOS, ANDROID, FIRE OS, etc.).

In some scenarios, the application state information 244 describes features of a function of the application when set to a particular state. In some implementations, the application state information 244 can include a description of the function. Put another way, the application state information can define a broad action, synonyms of the broad action, and terms that may be associated with the broad action. For example, if a function record 240 corresponds to a flight reservation functionality, the application state information 244 may include “make flight reservations” as a broad action, synonyms of the broad action (e.g., “buy plane tickets,” “search flights,” etc.), and terms or phrases associated typically associated with the broad action (e.g., “flights,” “vacation,” “travel to,” airport codes, city names, country names, etc.). In another example, a function records 240 corresponding to a restaurant searching functionality of an application may include a broad action “find a restaurant,” synonyms of the broad action (e.g., “search restaurants,” “find food,” etc.), and terms associated with the broad action (e.g., restaurant cuisines, city names, etc.).

The types of data included in the application state information 244 may depend on the type of information associated with the application state and the functionality of the application. In one example, if the function record 240 is for an application that provides reviews of restaurants, the application state information 244 may include information (e.g., text and numbers) related to a restaurant, such as a name of the restaurant, a category of the restaurant, actual reviews of the restaurant, ratings of the restaurant, an address of the restaurant, hours of operation of the restaurant, and a menu for the restaurant. As another example, if the function record 240 is for an application that plays music, the application state information 244 may include information related to a song, such as the name of the song, the artist, lyrics, and listener reviews and/or ratings. In some implementations, such data may be structured in predetermined fields to help facilitate the generation of result objects 132 that are transmitted in the search results 130.

In some implementations, the application state information 244 further includes what parameter types, if any, the application receives at a given state or when performing a particular function. For instance, if an application state corresponds to a travel application's flight booking functionality, the application state information 244 may include the following parameter types: a Boolean round trip parameter, a departure location (geolocation or a string designating an airport code), an arrival location (geolocation or a string designating an airport code), a departure date, a return date, an integer indicating a number of passengers, and a seat type (e.g., business class, first class, economy). In another example, if an application state corresponds to creating a calendar event functionality, the application state information 244 may include the following parameter types: a string indicating an event name, a time parameter indicating a start time, a time parameter indicating an end time, a string indicating guests or invitees, and a frequency parameter that indicates the days or dates to which the calendar event pertains (e.g., Monday thru Friday, the first of every month, etc.).

Referring back to FIG. 2B, the search module 212 identifies a consideration set of function records 240 based on the search query 102 (and possibly one or more context parameters), as well as the features described in the application state information 244 of the function records 240 stored in the data store 232. The search module 212 determines a result score for each function record 240 in the consideration set. In some implementations, the search module 212 associates the result score of a function record 240 with the function ID 242 of the function record 240. In this way, the search module 212 generates a set of scored function IDs 242. The search module 212 outputs the scored function IDs 242 to the results processing module 214. It is noted that the search module 212 may additionally or alternatively output scored function records 240 to the results processing module 214, which can include the function IDs 242 of the output records.

The results processing module 214 receives the scored function IDs 242 and generates search results 130 based thereon. In some implementations, the results processing module 214 identifies one or more function IDs 242 to base a result object 132 on based on the result score. The results processing module 214 accesses the result object records 250 stored in the data store 232 to generate the result objects 132.

FIG. 2D illustrates an example result object record 250 according to some implementations of the present disclosure. In the illustrated example, a result object record 250 can store one or more function IDs 242, display data 252, layout data 254, access mechanism data 256, and reference data 258. The result object record 250 can contain additional types of data not explicitly discussed without departing from the score of the disclosure.

The one or more function IDs 242 indicates the function records 240 to which the result object record 250 corresponds. In the instance that multiple function IDs 242 are stored in the result object record 250, then the result object records 250 can be used to generate result objects 132 corresponding to multiple function records 240. For example, if a particular result object record 250 can be used to generate result objects 132 for different states of an application (e.g., reviews of different restaurants), the function IDs 242 of the function records 240 describing the different states can be included in the particular result object record 250.

Display data 252 can include text data and image data. The text data can include any text to be included in a displayed search result 132′. For example, the text data can include, but is not limited to, a title of an application, a description of an application, a description of an application function or state, text describing how the application is relevant to the search query, and a rating of an application. The image data can include any images to be included in a displayed search result 132′. For example, the image data can include, but is not limited to, an application icon that represents the application, user interface images used for rendering the displayed search result 132′ (e.g., images such as screenshots). Image data may also include animations and videos.

Access mechanism data 256 can include any suitable information relating to the one or more access mechanisms that the results processing module 214 includes in a result object 132. In some implementations, the access mechanism data 256 includes the access mechanisms that correspond to a function ID 242 or function record 240. Put another way, the access mechanism data 256 can include one or more access mechanisms to access a particular state of an application. In some implementations, the access mechanism data 256 can include instructions for generating access mechanisms to access one or more states of an application. For example, the access mechanism data 256 can include templates for generating an application resource identifier and/or web resource identifiers. Each template can define a namespace corresponding to an application to be accessed and a manner by which to arrange one or more values within the resource identifier given the parameter type of each value. For example, a template for accessing a flight miles calculator of a native application called “MilesCalculator” may be of the form: “MilesCalculator:://[airport_code_2].[airport_code_2].roundtrip=[t/f]. In this example, the template takes in three parameters, a first airport code, a second airport code, and a Boolean flag indicating whether the trip is a round trip. In this way, an application access mechanism to access the flight miles calculator functionality of the “MilesCalculator” native application can be generated using the template, given a first airport code, a second airport code, and a designation of whether the flight is one-way or round-trip.

In another example, the access mechanism data can include templates that define operations for accessing a state or function of an application. For example, the templates can define a manner by which to generate a script to access a native application, and potentially to input one or more parameter values to the native application. Drawing from the “MilesCalculator” example, the template may include operations that cause the operating system to launch the MilesCalculator, and operations that cause the operating system to input a first airport code, a second airport code, and a Boolean flag indicating whether the flight is a round-trip to the MilesCalculator application. The latter operations may include parameter fields that receive the values that are either provided into the search query 102 and/or input into a displayed search result 132′ by a user. In this way, a script to access a particular functionality of an application given a set of parameter values may be generated either by the search engine 200 or a user device 300. In particular, the user device 300 can transmit the inputted parameters back to the search engine 200 and the search engine 200 can generate the script or the search engine 200 can provide the instructions and/or template for generating the script with the search results 130, whereby the user device 300 utilizes the instructions and/or template to generate the script.

Layout data 254 includes any suitable data that the user device 300 utilizes to render displayed search result 132′. Layout data 254 can include data that defines the “look and feel” of a displayed search result 132′. The layout data 254 may define the types of elements that appear in a displayed search result 132′ and where each element appears in a displayed search result 132′. For instance, the layout data 254 may define where an images (e.g., icons or screen shots of an application) appear in a displayed search result 132′, where text may appear in the displayed search result 132′, where input elements 134 may appear in the displayed search result 132′, where selection elements 136 may appear in a displayed search result 132′, and/or where tabs 138 are displayed in a displayed search result 132′. Further, the layout data 254 may define other visual features of a displayed search result 132′. For example, the layout data 254 may define the font and font size of text, the text to be displayed in certain elements (e.g., text to be displayed on input elements 134, selection elements 136, and tabs 138.

The layout data 254 defines the input elements 134 that can be included in a displayed search result 132′ as well as tabs 138. Examples of input elements 134 include pop-out windows, text input elements, menus, calendars, check boxes, radio buttons, slider bars. A pop-out window is a GUI element that is presented in the foreground of the SERP, leaving the previous interface in the background such that the pop-out window is overlaying the background. A pop-out window can display text and/or images, and may also include other input elements or other GUI elements. A text input element is an input element that allows a user to manually enter text. A menu is an input element 134 that allows a user to select from a predefined list of choices. In some examples, a menu may be presented as a menu bar. Additionally or alternatively, a menu may include sub-menus such that when an item in the menu is selected, a sub-menu is presented to the user. Calendars are input elements 134 that allow a user to enter one or more dates. In some implementations, calendars include pop-out windows that display a calendar where the user can select specific dates. Additionally or alternatively, a calendar may be implemented as one or more drop-down menus. Check boxes, radio buttons, and slider bars, are input elements that allow a user to toggle between two different input values (e.g., two different Boolean values). For example, check boxes, radio buttons, and/or slider buttons may prompt a user to select between one of two options (e.g., round-trip or one-way, male or female, yes or no, true or false, etc.).

The layout data 254 may further define other elements that can be displayed in a displayed search result 132′, such as link data and tab data. Link data can refer to data and instructions that cause the displayed search result 132′ (or a portion thereof) to behave as a user selectable link. The link data can define text or images that are rendered in the displayed search result 132′. The link data may further reference the access mechanism data 256 such that when a user selectable link is selected, the user device 300 displaying the search result 132′ accesses the resource based on the access mechanism data 256. In some scenarios, the link data may define a selection element 136. Tab data can define data that allows a user to navigate between two or more different tabs of a displayed search result 132′. Tab data can include names of the tabs, as well as can define the particular elements contained in each tab.

The layout data 254 may include input bindings that assign parameter types (e.g., variable names) to the input elements, such that when a user inputs a value into the input element 134, the user device 300 can assign the entered value to a particular parameter value. For example, if a displayed search result 132′ includes a text input element that receives values corresponding to a departure airport and the user enters a three letter airport code, the binding assigns the three letter airport code to a parameter that represents the departure airport. In this way, the user device 300 can use the inputted values to request or generate access mechanisms. In some implementations, the input binding can define the parameter types that are received by each input element. For instance, if a displayed search result includes a first calendar input element that receives a departure date and a second calendar input element that receives a return date, the input binding may indicate that the first calendar input element receives a departure date and the second calendar input element receives a return date. In this way, the parameter types of each input element in a displayed search result may be identified. Further, in some implementations, the parameter types may be defined according to a predefined schema so as to have conformity of parameter types in search results that link to the same type of function.

The layout data 254 may further include output bindings. An output binding maps values (e.g., an application name, application description, a state name, an application icon, etc.) to various elements of the displayed search result 132′. For example, an element within a displayed search result 132′ may display a name of a state, and the display data 252 may define a name of a particular state or application. In this example, the binding may bind the defined name of the state to the element that displays the names of a state, such that when rendered, the displayed search result 132′ outputs the name of the state or application.

In some implementations, the layout data 254 may be encoded in a layout file. A layout file can contain a layout object and one or more bindings. The layout file defines the layout of a displayed search result. For example, the layout file can define where each element is located within a displayed search result, the fonts used in each element, the size of each element, and/or the data types of each element. The one or more bindings can include an input binding and an output binding. In this way, content may be presented in a displayed search result 132′ and information may be received via the displayed search result 132′ in accordance with the layout file. In some implementations, a layout file is provided by an application developer. In these implementations, the application developer can develop custom-made search results. For example, an application developer can decide how displayed search results 132′ linking to states of its application appear to a user.

In some implementations, a layout file may be referenced by a layout identifier (layout ID). A layout ID can be a string made up of characters, numbers, and/or symbols that uniquely identify a layout file. In these implementations, a layout file may be stored at the search engine 200, a third party resource, or at the individual user devices 300 and referenced using the layout ID. In implementations where layout files are stored at the individual user devices 300, a result object 132 can include a layout ID and the user device 300 can retrieve the layout file corresponding to the layout ID and render the displayed search result 132′ based on content defined in the result object 132 and the retrieved layout file.

Reference data 258 includes data that references third party resources (e.g., web servers and/or application servers). According to some implementations, at least a portion of the information used to render a displayed search result 132′ may be obtained from a third party resource. The reference data 258 may identify the third party resource from which the information may be obtained. In this way the search engine 200 may support application functions that depend on real-time data. For example, an application may allow users to make reservations for restaurants. In this example, the reference data 258 may indicate an address of a server associated with the application where available reservation times may be obtained. In this way, the search engine 200 or the user device 300 can request and obtain the available reservation times at query-time or rendering-time, thereby insuring that the content that is presented in the displayed is valid and/or fresh data. The reference data 258 may include resource identifiers (e.g., web resource identifier) where the content may be obtained. In some implementations, the reference data 258 may additionally or alternatively define a location where a layout file may be obtained.

FIG. 2E illustrates a search module 212 according to some implementations of the present disclosure. The search module 212 can include a query analysis module 216, a set generation module 218, and a scoring module 220. The query analysis module 216 receives search queries 102 and outputs tokens based thereon. The set generation module 218 receives the tokens and identifies a consideration set of function records 240 (referred to as a “consideration set of records” or “consideration set”) based on the tokens. The consideration set of records may contain actual function records 240 or the function IDs 242 thereof. The scoring module 220 receives the consideration set of records and scores each function record 240 identified in the consideration set. The scoring module 220 can attribute the score of a function record 240 to its function ID 242. The scored function IDs 242 are output to the results processing module 214. The operation of the search module 212 is described in greater detail below.

The query analysis module 216 receives a search query 102, and in some implementations, context parameters (e.g., geolocation of a user device 300 or an operating system type of the user device 300). When the query analysis module 216 receives a search query 102, the query analysis module 216 analyzes the query terms of the search query 102 and/or the context parameters. For example, the query analysis module 216 may perform various analysis operations on the query terms of the received search query 102. Example analysis operations may include, but are not limited to, tokenization of the search query 102, filtering of the search query 102, stemming the query terms of the search query, synonymization of the search terms, and stop word removal. In some implementations, the query analysis module 216 outputs tokens representing the search query 102.

The set generation module 218 identifies a consideration set of records based on the tokens provided by the query analysis module 216. As used herein, the term consideration set of records can refer to a list of function IDs 242 or a collection of actual function records 240. In some examples, the set generation module 218 may identify the function records 240 based on matches between the tokens and terms contained in the function records 240. For example, the set generation module 218 may identify the function records 240 based on matches between tokens generated by the query analysis module 216 and terms included in the application state information 244 (which may also be tokenized). The set generation module 218 may further determine an initial score for each identified record (and not the result score of the record). In some implementations, the set generation module 218 may utilize the Apache Lucene libraries supported by the Apache Software Foundation to identify the consideration set and obtain the initial scores thereof.

The scoring module 220 scores the function records 240 indicated by the consideration set. The scores associated with the function records 240 may be referred to as “result scores.” The scoring module 220 may determine a result score for each of the function records 240 identified the consideration set. The result scores associated with a function record 240 may indicate the relative rank of relevance of the function record 240 with respect to the other function records 240. For example, a larger result score may indicate that a function record 240 is more relevant to the search query 102. The information conveyed by the search results 130 may depend on how the result scores are calculated by the scoring module 220. For example, the result scores may indicate the relevance of an application function or application state to the search query 102, the popularity of an application function or state, and/or other properties of the application function or state, depending on what attributes the scoring module 220 uses to score the function records 240.

The scoring module 220 may generate result scores for function records 240 in any suitable manner. In some implementations, the scoring module 220 generates a result score for a function record 240 based on one or more scoring features. The scoring features may be associated with the function record 240 and/or the search query 102. A function record-scoring feature (hereinafter “record scoring feature”) may be based on any data associated with a function record 240. For example, record-scoring features may be based on any data included in the application state information of the function record 240. Example record scoring features may be based on metrics associated with a person, place, or thing described in the function record 240. Example metrics may include the popularity of a place described in the function record and/or ratings (e.g., user ratings) of the place described in the function record 240. In one example, if the function record 240 describes a song, a metric may be based on the popularity of the song described in the function record 240 and/or ratings (e.g., user ratings) of the song described in the function record 240. The record scoring features may also be based on measurements associated with the function record 240, such as how often the function record 240 is retrieved during a search and how often access mechanisms of the function record 240 are selected by a user when appearing in the search results 130. Record scoring features may also be based on whether the function record 240 describes a default state or a deeper application state.

A query-scoring feature may include any data associated with the search query 102. For example, query scoring features may include, but are not limited to, a number of words in the search query 102, the popularity of the search query 102 (e.g., how often the search query 102 is received by the search engine 200 or the total number of times the search query 102 has been received by the search engine 200), and the expected frequency of the words in the search query 102. A record-query scoring feature may include any data generated based on data associated with both the function record 240 and the search query 102 that resulted in identification of the function record 240 by the set generation module 218. For example, record-query scoring features may include, but are not limited to, parameters that indicate how well the terms of the search query 102 match the terms of the application state information of the identified function record 240 (e.g., the initial score assigned to the function record by the set generation module 218).

The scoring module 220 may generate a result score for a function record 240 based on at least one of the record scoring features, the query scoring features, and the record-query scoring features. The scoring module 220 may determine a result score based on one or more of the scoring features listed herein and/or additional scoring features not explicitly listed. In some examples, the scoring module 220 may include one or more machine learned models (e.g., a supervised learning model) configured to receive one or more scoring features. The one or more machine learned models may generate result scores based on at least one of the record scoring features, the query scoring features, and the record-query scoring features. For example, the scoring module 220 may pair the search query 102 with each function record 240 and calculate a vector of features for each (query, record) pair. The vector of features may include one or more record scoring features, one or more query scoring features, and one or more record-query scoring features. The scoring module 220 may then input the vector of features into a machine-learned regression model to calculate a result score for the function record 240. In some examples, the machine-learned regression model may include a set of decision trees (e.g., gradient boosted decision trees). In another example, the machine-learned regression model may include a logistic probability formula. In some examples, the machine learned task can be framed as a semi-supervised learning task, where a minority of the training data is labeled with human curated scores and the rest are used without human labels.

The scoring module 220 associates each calculated result score with the function ID 242 of the record 240 to which the calculated score corresponds. The scoring module 220 can provide the scored function IDs 242 to the results processing module 214.

FIG. 2F illustrates an example data flow of the results processing module 214. The results processing module 214 receives scored function IDs 242 and generates result objects 132 based thereon. The results processing module 214 can determine which function IDs 242 on which to base result objects 132 according to the respective scores thereof. In some implementations, the results processing module 214 can rank the function IDs 242 based on their respective scores. The ranked list of function IDs 242 can define the order in which the displayed search results 132′ appear in the SERP. Additionally or alternatively, the results processing module 214 can discard any function IDs 242 whose result score does not exceed a threshold.

Furthermore, the results processing module 214 can determine the size and appearance of each displayed search result 132′ based on the respective scores. For instance, a displayed search result 132′ based on a function ID 242 that has a higher score can be sized bigger than an displayed search result 132′ that is based on a function ID 242 having a lower score.

In operation, the results processing module 214 receives a scored function ID 242 and can generate a result object 132 based thereon. Assuming a function ID 242 has a requisite result score associated therewith (e.g., the result score of the function ID 242 is above a threshold or is in the nth percentile of function IDs 242), the results processing module 214 retrieves a result object record 250 from the data store 232 using the function ID 242. As was previously discussed, the result object records 250 store function IDs 242 of corresponding function records 240, according to some implementations. The retrieved result object record 250 includes at least a portion of the result object data used to generate a result object 132. The results processing module 214 generates a result object 132 based on the layout data 254 contained in the result object record 250. In some implementations, the retrieved result object record 250 includes a layout file (or a layout ID pointing to a layout file) and display data 252. The layout file may include a layout object that defines the structure and/or functions used to generate and manipulate a result object 132. In these implementations, the results processing module 214 can instantiate a result object 132 (or a portion thereof) based on the layout object. The results processing module 214 can populate fields defined in an instantiated result object 132 using the display data 252. For example, the results processing module 214 can assign values to various fields defined in the instantiated result object 132 using content defined in the display data 252 (e.g., application name, application state description, icons, etc.). Alternatively, the results processing module 214 may retrieve the function record 240 corresponding to the function ID 242 corresponds and populate the fields defined in the instantiated result object 132 using the application state information 244 defined in the function record 240. In some implementations, the results processing module 214 utilizes an output binding defined in the layout file to bind values in the display data 254 and/or the application state information 244 of the function record 240 to the instantiated result object 132.

The results processing module 214 inserts access mechanism data 256 in each instantiated result object 132. The user device 300 utilizes the access mechanism data 256 to access a state or function of an application indicated by the displayed search result 132′. In some implementations, the result object record 250 corresponding to a function ID 242 includes one or more access mechanisms (e.g., a web resource identifier, an application resource identifier, and/or a script) that can be used to access a state or function of an application. In these implementations, the result-processing module 214 retrieves the access mechanisms from the result object record 250 and populates one or more fields of the instantiated result object 132 with the one or more access mechanisms. In some implementations, the results processing module 214 references a lookup table that associates function IDs with corresponding access mechanisms. In these implementations, the results processing module 214 identifies one or more access mechanisms from the lookup table based on their respective association with a function ID 242. The results processing module 214 populates one or more fields of the instantiated result object 132 with the identified access mechanisms. In some implementations, the access mechanism data 256 can define one or more specifications or templates for generating access mechanisms. In these implementations, the results processing module 214 includes one or more of the specifications or templates defined in a record 250 in the result object 132, such that the user device 300 can generate an access mechanism to access a state or function of an application based on the specification or template and the input entered into a displayed search result 132′ by a user.

The results processing module 214 can include any other suitable data in a result object 132. For instance, the results processing module 214 can include a function tag in the result object. The function tag indicates a function of a software application that can be accessed by a displayed search result 132′ that is generated based on the result object 132.

The results processing module 214 can transmit the generated result objects 132 to the user device 300 which transmitted the search query 102. The user device 300 receives and renders the search results 130 into displayed search results 132′.

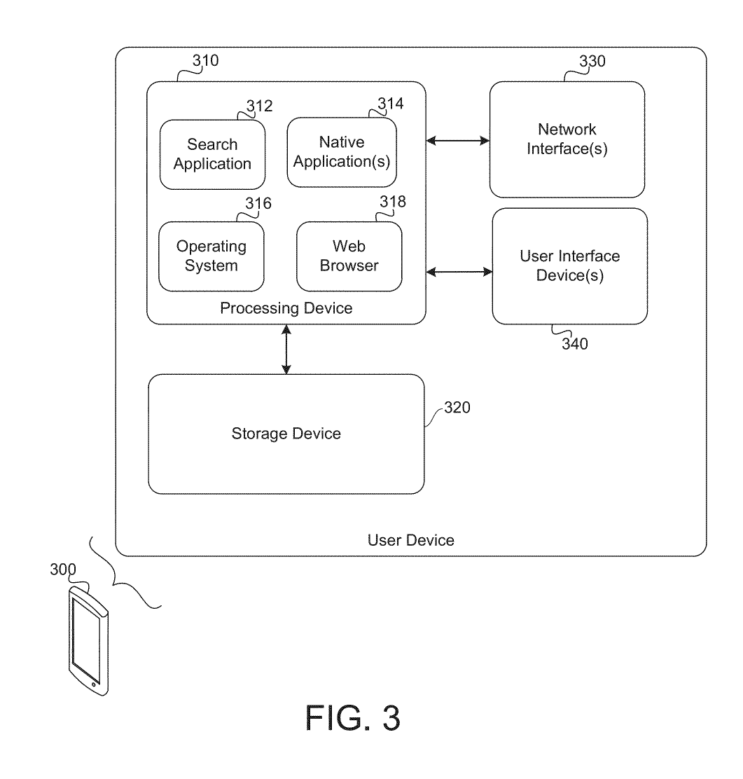

FIG. 3 illustrates a user device 300 configured to perform searches. In particular, the user device 300 is configured to provide search queries 102 to the search engine 200 and to render search results 130 received from the search engine 200. In the illustrated example, the user device 300 includes a processing device 310, a storage device 320, a network interface 330, and a user interface 340.

The processing device 310 includes memory (e.g., RAM and/or ROM) that stores computer-readable instructions and one or more processors that execute the computer-readable instructions. In implementations where the processing device 310 includes two or more processors, the processors can execute in a distributed or individual manner. The processing device 310 may execute a search application 312, an operating system 316, a web browser 318, and one or more native applications 314, all of which may be embodied as computer-readable instructions. The storage device 320 includes one or more computer-readable mediums (e.g., hard disk drive and/or flash memory). The storage device 320 can store the computer-readable instructions that make up the search application 312, the web browser 318, the operating system 316, and the one or more native applications 314.

The network interface 330 includes one or more devices that are configured to communicate with the network. The network interface 330 can include one or more transceivers for performing wired or wireless communication. Examples of the network interface 330 can include, but are not limited to, a transceiver configured to perform communications using the IEEE 802.11 wireless standard, an Ethernet port, a wireless transmitter, and a universal serial bus (USB) port. The user interface 340 includes one or more devices that receive input from and/or provide output to a user. The user interface 340 can include, but is not limited to, a touchscreen, a display, a QWERTY keyboard, a numeric keypad, a touchpad, a microphone, and/or speakers

The search application 312 displays a search bar and receives search queries 102 via the search bar. In particular, a user can enter one or more query terms into the search bar. In some implementations, the search application 312 waits until the user executes the search (e.g., presses upon a “search” button displayed in relation to the search bar) to transmit a search query 102 to the search engine 200. In response to the search query 102, the search engine 200 responds with search results 130. The search application renders and displays the search results 130 in the SERP.

In other implementations, the search application 312 transmits the contents of the search query 102 as the user enters the query terms. In these implementations, the search application 312 can transit a new search query 102 each time the user enters a character into the search bar and the search engine 200 can update the search results 130 as the user continues to enter the search query 102. In response to the updated search results 130, the search application 312 renders and displays the search results 130 in the SERP.

The search application 312 can receive a user selection of a displayed search result 132′. In response to the selection of a displayed search result 132′, the search application 312 can access a state or function of the application indicated by the displayed search result 132′. In some scenarios, a displayed search result 132′ includes one or more input elements 134. In the instance that a user respectively enters one or more values into the one or more input elements 134, the search application 312 obtains an access mechanism for accessing the application and accesses the application indicated by the displayed search result 132′ using the access mechanism. In some implementations, the result object 132 from which the displayed search result 132′ was rendered includes one or more specifications or templates for generating an access mechanism given a set of parameter types. For example, if a displayed search result 132′ allows a user to enter values for making hotel reservations (e.g., FIG. 1C), the user may enter a location (e.g., a city name), a check-in date, a checkout date, a number of rooms, and a number of guests. The search application utilizes the inputted values to obtain an access mechanism. In some implementations, the search application 312 obtains one or more access mechanisms that are based on the inputted values using access mechanism data 256 transmitted in the result object 132 on which the selected displayed search result 132′ was based. For example, the search application 312 may utilize a template to generate an application resource identifier given a set of parameters (e.g., a location, a check-in date, a checkout date, a number of guests, and a number of rooms). The search application 312 can utilize an input binding or similar mechanism to identify the parameter type of each value. For each identified parameter type, the search application 312 can populate a corresponding field in the template with the inputted value that was mapped to the parameter type. In this way, the search application 312 generates an application access mechanism that accesses a state or function of the native application edition of the application using the inputted parameters. The access mechanism data can include templates or specifications for generating scripts and/or web resource mechanisms. The search application 312 can generate scripts and/or web resource identifiers in the manner described above. In other implementations, the search application 312 provides a request to the search engine 200 to generate one or more access mechanisms given the inputted values. The requests can include fields defining different parameter types, and each field may have an inputted value assigned thereto. In response to the request, the search engine 200 generates one or more access mechanisms based on the inputted values and transmits the one or more access mechanisms to the user device 300. In some implementations, the search engine 200 generates the one or more access mechanisms in the manner described above.

When a user selects a displayed search result 132′, the search application 312 accesses a state or function of an application using an access mechanism. Accessing an application can include determining whether a native application edition of the application referenced by the access mechanism is installed on the user device 300. If so, the search application 312 instructs the operating system of the user device 300 to launch the native application and to set the state of the native application in accordance with the access mechanism. In some implementations, if a native application edition of the application is not installed, the search application can instruct the operating system to launch the web browser application and access the state of the web application edition of the application using a web resource identifier. Additionally or alternatively, the search application 312 can prompt a user to download the application. In this scenario, the search application 312 can instruct the operating system to launch a digital distribution application, whereby the user can elect to download the native application edition. In such implementations, the search application 312 can access the state of the application once the native application edition is downloaded.

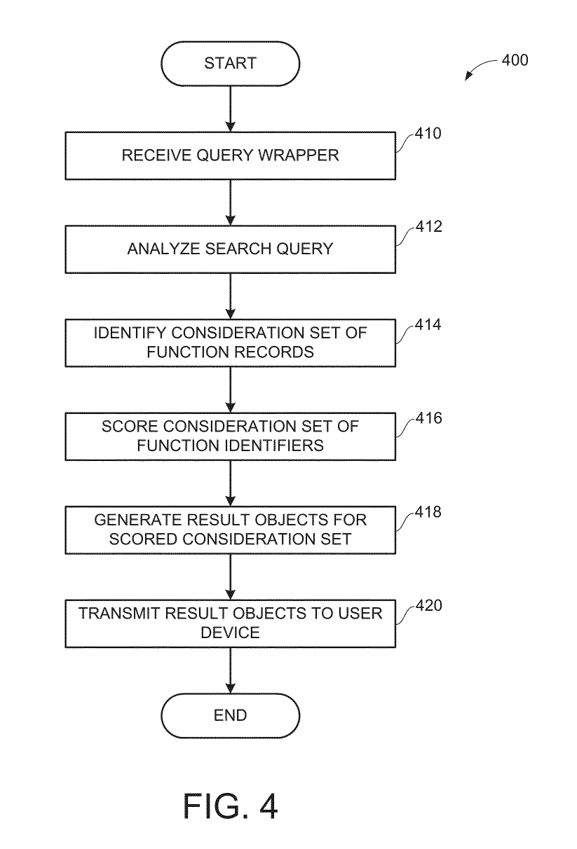

FIG. 4 illustrates an example set of operations of a method 400 for processing a search query 102. For purposes of explanation, the method 400 is explained with respect to the search engine 200 of FIGS. 2A-2F and is executed by the processing system 210 thereof. The method 400 may, however, be executed on any suitable computing device.

At operation 410, the query analysis module 216 receives a query wrapper 100 from a user device 300. The query wrapper 100 contains a search query 102 and may contain additional context parameters 104. At operation 412, the query analysis module 216 analyzes the search query 102, and in some implementations, the additional context parameters 104. The query analysis module 216 parses and analyzes the search query 102 and outputs one or more tokens. As previously discussed, the search query 102 contains one or more query terms. The query analysis module 216 can stem the search query 102, synonymize the search query 102, remove stop words from the search query 102, and/or tokenize the search query 102. The query analysis module 216 outputs one or more tokens representing the search query 102 (and potentially the context parameters) to the set generation module 218.

At operation 414, the set generation module 218 identifies a consideration set of function records based on the one or more tokens. The set generation module 218 can search the data store 232 using the tokens. As previously discussed, in some implementations the set generation module 218 utilizes the Lucene Library to search and identify a consideration set of function records 240. The consideration set of function records 240 includes function IDs 242 of function records 240 (or the function records 240 themselves) that at least matched a minimum number of tokens to the search query 102. In some implementations, each function record 240 identified in the consideration set is also provided an initial score based on the degree to which the function record 240 matched to the tokens of the search query 102. The set generation module 218 outputs the consideration set to the scoring module 220.

At operation 416, the scoring module 220 scores each record in the consideration set and outputs the scored consideration set to the results processing module 214. The scoring module 220 receives the consideration set from the set generation module 218. For each function ID 242, the scoring module 220 can retrieve the corresponding function record 240 and calculate a score based on the contents of the record 240. In some implementations, the scoring module 220 includes a machine-learned scoring model that scores a function record 240 based on a number of scoring features, including features of the function record 240, features of the search query 102, and/or features of the function record 240 as it relates to the search query 102. The scoring module 220 outputs the scored consideration set of records to the results processing module 214.

At operation 418, the results processing module 214 generates result objects 132 based on the scored consideration set. In some implementations, the results processing module 214 ranks the function IDs 242 included in the consideration set based on the respective results scores of the function IDs 242. Additionally or alternatively, the results processing module 214 determines the function IDs 242 on which to base the search results 130 based on the results scores. For instance, the results processing module 214 can keep function IDs 242 having results scores that exceed a minimum threshold or the function IDs 242 having results scores in the nth highest percentile.

The results processing module 214 generates result objects 132 based on the function IDs 242 that are kept. In some implementations, the results processing module 214 retrieves result object records 250 from the data store 232 using the function IDs 242. For each retrieved result object record 250, the results processing module 214 generates a result object 132 using the layout data 254 and the access mechanism data 256. Furthermore, the results processing module 214 can include display data 252 in the result object 132 and/or reference data 258 (which identifies resources where additional data can be requested). In some implementations, the results processing module 214 instantiates a layout object from a layout file and binds content to the layout object using an output binding. The content may be defined in the display data 252 and/or the application state information 244 defined in the function record 240 corresponding to the function ID 242 on which the result object 132 is based. At operation 420, the results processing module 214 transmits the generated result objects 132 to the user device 300 that transmitted the request.

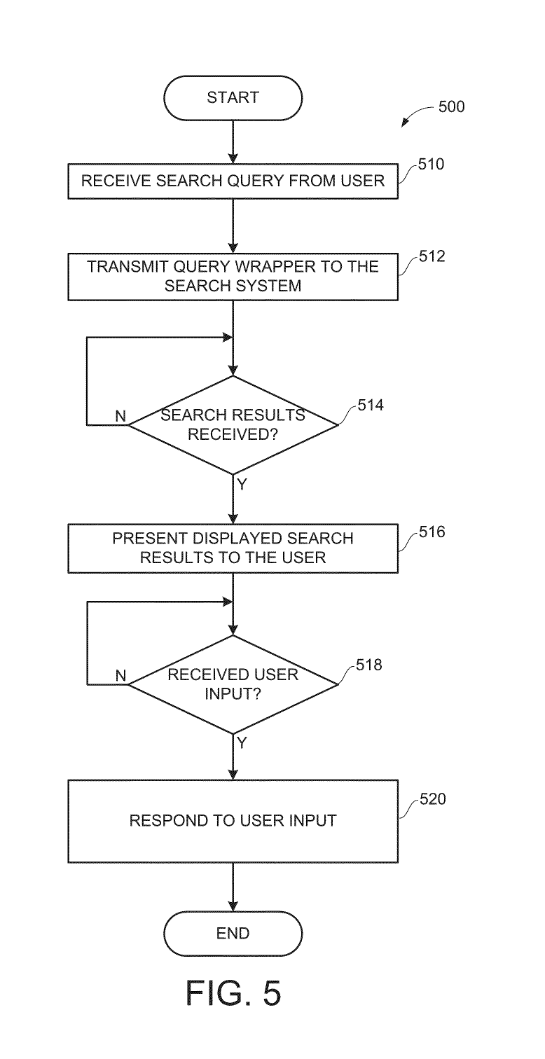

FIG. 5 illustrates an example set of operations of a method 500 for performing a search on a user device 300. The method 500 is explained with reference to the search application 312 being executed by the processing device 310 of the user device 300. The method 500, however, may be performed by any suitable application executing on the user device 300.

At operation 510, the search application 312 receives a search query 102 from a user. A user can enter the search query 102 into a search bar displayed in a GUI by the search application 312. The search application 312 can determine any additional context parameters to include in the search query 102 (e.g., geolocation, operating system type, username, etc.).

At operation 512, the search application 312 transmits a search query 102 to the search engine 200. The search application 312 can generate a query wrapper 100 that contains the search query 102 and, in some implementations, any context parameters determined by the search application 312. The search application 312 can transmit the search query 102 when the user instructs the search application 312 to transmit the search query 102 (e.g., by pressing a “search” button) or each time the user enters a new character in the search bar.

At operation 514, the search application 312 waits to receive search results 130 from the search engine 200. When the search application 312 receives the search results 130, the search application 312 renders the result objects 132 contained in the search results 130 into respective displayed search results 132′ and presents the displayed search results 130′ in the SERP, as shown at operation 516. One or more of the displayed search results 132′ may include input elements 134.

At operation 518, the search application 312 waits for user input, and when the user input is received, the search application 312 responds to the user input at operation 520. In some scenarios, a user provides user input in relation to a displayed search result 132′ that includes input elements 134. In these scenarios, user input can include entering values into one or more input elements 134, selection of a tab 138, selection of a header 137, and/or selection of a selection element 136.

In the case a user selects a tab 138, the search application 312 alters the information displayed in the displayed search result 132′. For example, a displayed search result 132′ may display a first set of input elements 134 to access a first function of an application, while a tab 138 may indicate a second set of input elements 134 to access a second function of an application, whereby the second set of input elements 134 are not shown in the displayed search result 132′. In response to selection of the tab 138 (e.g., pressing on the tab 138), the search application 312 alters the appearance of the displayed search result 132′ thereby displaying a portion of the displayed search result 132′ corresponding to the hidden elements (e.g., the second set of input elements 134).

In the case a user enters values into one or more input elements 134, the search application 312 can display the inputted values in the input elements 134. The user can then select a selection element 136 to execute the displayed search result 132′. In response to selection of the selection element 136, the search application 312 obtains one or more access mechanism(s) corresponding to the inputted values. In some implementations, the search application 312 requests the access mechanism(s) from the search engine 200, whereby the request includes the inputted values. In other implementations, the search application 312 generates the access mechanisms(s) using a specification or template defined in the result object 132 and the inputted values. The search application 312 can then access the state or function of the application using one of the one or more access mechanisms. For instance, the search application 312 can determine whether a native application edition of the application is installed on the user device 300, and if so, instruct the operating system to launch the native application edition using the access mechanism. The operating system launches the native application edition and sets the state of the application in accordance with the access mechanism (in this case an application access mechanism). If the native application edition is not installed, the search application 312 can instruct the operating system to launch the web browser application and to access the state or function of the application using a web resource identifier.

In some implementations, the selection of a header 137 causes the search application 312 to access a default state of an application. For instance, the search application 312 can determine whether a native application edition of the application is installed on the user device 300, and if so, the search application 312 instructs the operating system to launch the native application edition to a default state using a default application access mechanism. The operating system launches the native application edition and sets the state of the application to the default state.

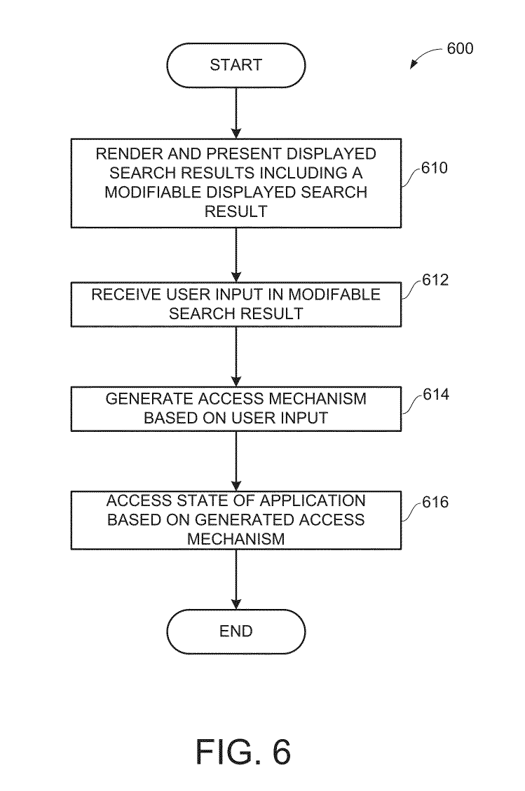

FIG. 6 illustrates an example set of operations of a method 700 for accessing a state of an application. The method 600 is explained with respect to the search application 312. The method 600, however, may be executed by any suitable application.

At operation 610, search application 312 renders and presents displayed search results 130′ in the SERP, including a displayed search result 132′ that includes one or more input elements 134. The search application 312 receives the search results 130 in response to a search query 102, as was described above.

At operation 612, search application 312 receives user input in one or more input elements of the displayed search result 132′. The user may enter values into the input elements 134 via the user interface 340 of the user device 300. The user can then execute the displayed search result 132′ by, for example, selecting a selection element 136 displayed in relation to the displayed search result 132′.

At operation 614, the search application 312 generates one or more access mechanisms based on the values entered into the input elements 134. In some implementations, the search application 312 associates the values inputted by the user with parameter types accepted by the application indicated by the displayed search result 132′ using an input binding. As previously discussed, an input binding may be communicated in the result object 132 from which the displayed search result 132′ is rendered. The input binding associates the input elements 134 to respective parameter types accepted by the application indicated by the search result 132′. In this way, the search application 312 can associate the inputted values to the parameter types accepted by the application. The search application 312 then generates one or more access mechanisms based on access mechanism data 256 contained in the result object 132 from which the displayed search result 132′ was generated. For example, the access mechanism data 256 may contain a first template for generating an application resource mechanism and a second template for generating a web resource identifier. In some examples, the templates include a first portion that indicates the web or native application edition of the application and a second portion that defines a scheme for accessing a state or function of the application. The scheme may include fields that respectively define parameter types and receive values. The search application 312 can substitute the values inputted into the displayed search result 132′ into the fields of the templates. In some implementation, the search application 312 utilizes the associations between the inputted values and the known parameter types to populate the fields of the templates, thereby generating the access mechanisms. The search application 312 may generate the access mechanisms in any other suitable manner. For instance, the search application 312 may utilize a specification that defines instructions for generating access mechanisms for a particular application given a set of inputted values with known parameter types.

At operation 616, the search application 312 accesses the application using the generated access mechanism(s). As was previously discussed, the search application 312 may determine whether a native application edition of the application is installed on the user device 300, and if so, the search application 312 the native application edition using an application resource identifier. Otherwise, the search application 312 may access a web application edition of the application using a web resource identifier. Additionally or alternatively, the search application 312 may prompt the user to download a native application edition of the application if it is not already installed on the device 300. In such a scenario, the search application 312 may access the downloaded native application edition using the application resource identifier upon receiving confirmation that the native application edition has been downloaded to and installed on the user device 300.

The methods 400, 500, 600 described above are provided for example only and not intended to limit the scope of the disclosure. The ordering of the operations is not mandatory and some operations may be performed in parallel. Further alternate or additional operations not explicitly described may be performed as well.

Referring back to FIG. 3, in some implementations, the search application 312 is configured to replicate user input across different displayed search results 132′. In these implementations, the search application 312 receives a search query 102 from a user and transmits the query 102 to the search engine 200. The search engine 200 replies to the search query 102 with search results 130. As discussed, the search application 312 displays the displayed search results 130′, whereby one or more of the individual displayed search results 132′ can include input elements 134. In some scenarios, two or more of the displayed search results 132′ will be functionally similar. Displayed search results 132′ may be referred to as functionally similar if the displayed search results 132′ can link to the same or similar functions of the respective software applications indicated by the displayed search result 132′. In the scenario when two or more displayed search results 132′ are functionally similar and the user inputs values into the input elements 134 of a first displayed search result 132′, the search application 312 can replicate the values into corresponding input elements 134 of the other functionally similar displayed search results 132′. In this way, a user does not need to repeat the processes of retyping the values into the input elements 134 of the other functionally similar displayed search results 132′.

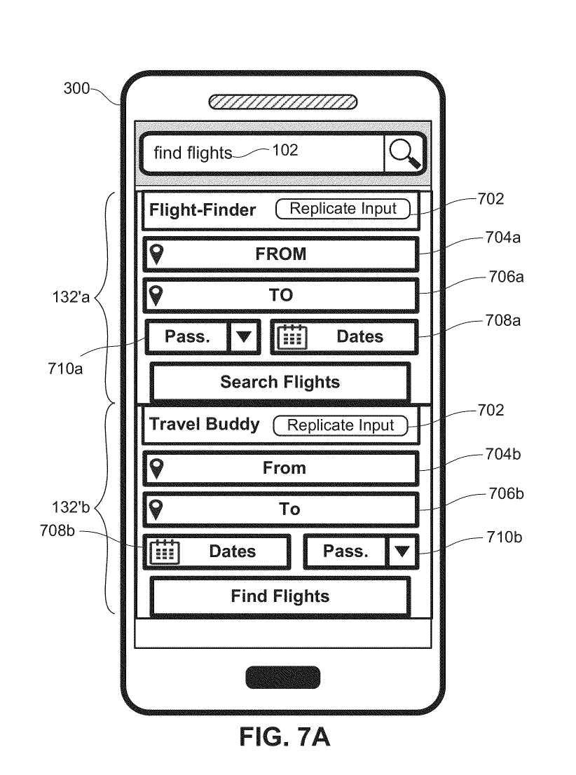

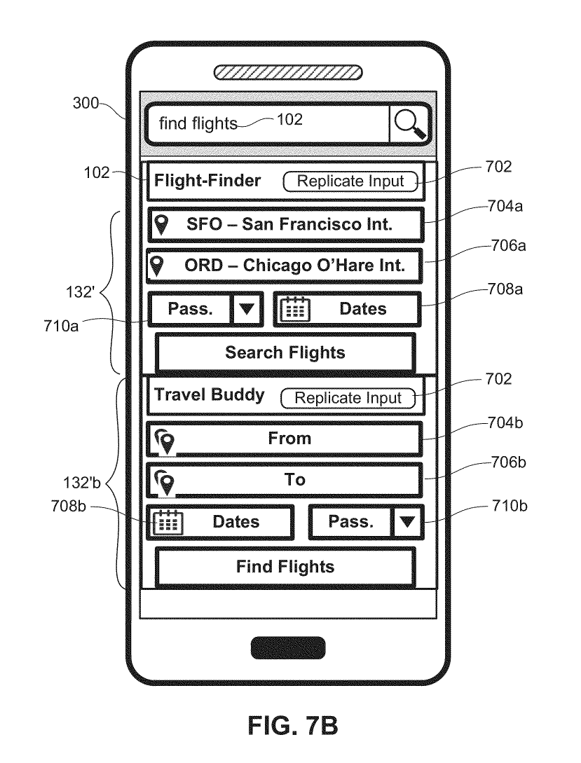

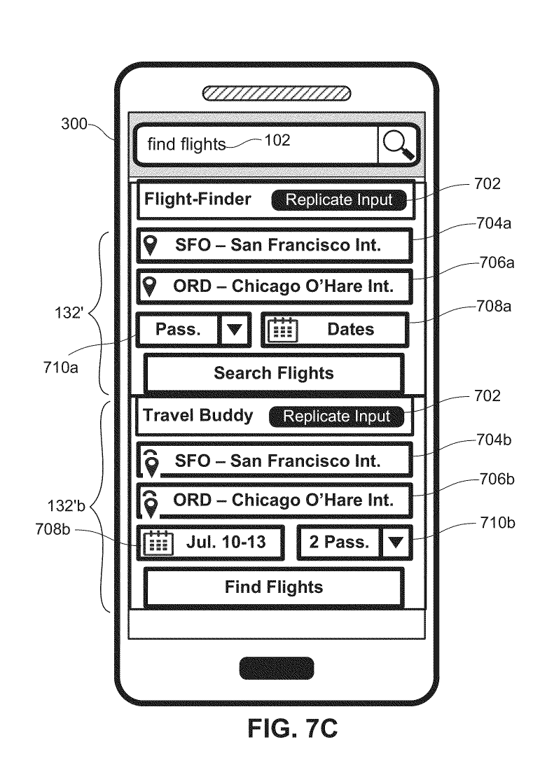

FIGS. 7A-7C illustrate an example of the search application 312 replicating user input. The SERP illustrated in FIGS. 7A-7C is provided for example only and not intended to limit the scope of the disclosure.

In FIG. 7A, the search application 312 is displaying displayed search results 130′ in response to the search query 102 “find flights.” The search results 130′ include two displayed search results 132′a, 132′b. The first displayed search result 132′a links to a software application called “Flight-Finder.” The second displayed search result 132′b links to a software application called “Travel Buddy.” Both software applications allow users to search for flights. Furthermore, both displayed search results 132′a, 132′b implicate the flight searching functions of the respective software applications. In other words, both displayed search results 132′a, 132′b receive user input that can be used to find different flight options. Thus, the first and second displayed search result 132′a, 132′b may be referred to as functionally similar.

In the illustrated example, the first displayed search result 132′a includes a text input element 704a that receives a departure airport, a text input element 706a that receives an arrival airport, a calendar input element 708a that receives a departure date and return date, and a menu input element 710a that allows a user to select the number of passengers. The second displayed search result 132′b also includes a text input element 704b that receives a departure airport, a text input element 706b that receives an arrival airport, a calendar input element 708b that receives a departure date and return date, and a menu input element 710b that allows a user to select the number of passengers. A user can enter user input into either of the displayed search result 132′a, 132′b and select one of the displayed search results to access the flight finding function of the respective software applications. Furthermore, in response to the user input (e.g., values) entered into the input elements 704, 706, 708, 710 the search application 312 can access a state of the software application that is dependent on the user input. For instance, the user may view the prices of round-trip flights between two specified airports on two specified dates, for a specified number of passengers.

FIG. 7B illustrates the user device 300 of FIG. 7A after the user has entered user input into the first displayed search result 132′a. In particular, the user has entered a first value indicating a departure airport code (e.g., “SFO . . . ”) in the first text input element 704a, a second value indicating an arrival airport code (e.g., “ORD . . . ”) in the second text input element 706a, a third value indicating an departure date and a return date (e.g., July 10-13) in the date input element 708a, and a number of passengers (e.g., two passengers) in the menu input element 710b. At this juncture, the second displayed search result 132′b has not received any input. It is noted that the search application 312 may be configured to perform autocomplete of fields and/or may display popups to assist the user in providing the user input. For example, the user may enter the term “SFO” and the search application 312 may autocomplete the term to “SFO-San Francisco Int.”

In some implementations, the search application 312 can display one or more replicate selection elements 702. A replicate selection element 702 can be selected by a user to instruct the search application to replicate the user input received in one displayed search result 132′ to other displayed search result 132′. In the illustrated example of FIGS. 7A-7C, the replicate selection elements 702 are displayed in the headers 137 of the displayed search results 132′. When the user selects the replicate selection element 702, the search application 312 is instructed to replicate the user input. In other implementations, the search application replicates user input across functionally similar displayed search results 132′ automatically as the user inputs values into the input elements of one of the displayed search results 132′.

In FIG. 7C, the search application 312 has replicated the user input entered into the first displayed search result 132′a into the second search result 132′b. In the illustrated example, the search application 312 replicated the user input in response to the user's selection of the replicate selection element 702. As shown, the search application 312 has inserted the first value (e.g., “SFO”) indicated in the first text input element 704a of the first displayed search result 132′a into the first text input element 704b of the second displayed search result 132′b. Similarly, the search application 312 has inserted the second value (e.g., “ORD”) of the second text input element 706a of the first displayed search result 132′a into the second text input element 706b of the second displayed search result 132′b. The search application has 312 also inserted the dates (e.g., July 10-13) entered into the date input element 708a of the first displayed search result 132′a into the date input element 708b of the second displayed search result 132′b. The search application 312 has also input the number of passengers (e.g., two) selected in the menu input element 710a of the first displayed search result 132′a into the menu input element 710b of the second displayed search result 132′b. In this way, the search application 312 has replicated the user input of the first displayed search result 132′a in the second displayed search result 132′b, thereby parameterizing the second displayed search result 132′b. In this way, the user can select the second displayed search result 132′ to find prices and flight times of round trip flights between San Francisco International Airport and Chicago O'Hare International Airport on July 10^{th} and 13^{th} for two people using the Travel Buddy software application, despite never having entered user input into the Travel Buddy displayed search result 132′b.

In operation, the search application 312 can determine whether two or more of the displayed search results 132′ are functionally similar. In some implementations, the search engine 200 may include a function tag in each result object 132, whereby the function tag identifies the function of a software application that can be accessed by selecting the displayed search result 132′ (e.g., “make reservation,” “buy movie tickets,” or “make flight reservation”). In these implementations, the search application 312 can receives the result objects 132 and identifies functionally similar displayed search results 132′ based on the function tags contained therein. In other implementations, the search application 312 analyzes the parameter types received by the input elements of the displayed search result 132′ and identifies the functionally similar displayed search results 132′ based on the parameter types respectively received by the input elements of the displayed search results 132′. The search application 312 may analyze the input bindings of each displayed search results to determine the parameter types respectively received by the input elements of the displayed search results 132′. For example, if two displayed search results 132′ receive a first airport code, a second airport code, a departure date, a return date, and a number of passengers, the search application 312 can identify the displayed search results 132′ as being functionally similar. In other implementations, the search engine 200 identifies the functionally similar displayed search results 132′ and lists the result object IDs of other functionally similar displayed search results 132′ in a result object 132 of a displayed search result 132′. For example, in the examples of FIGS. 7A-7C, the search engine 200 can include a result object ID of the second displayed search result 132′b in the result object 132 used to generate the first displayed search result 132′a. Similarly, the search engine 200 can include the result object ID of the first displayed search result 132′a in the result object 132 used to generate the second displayed search result 132′b. In this way, when the search application 312 replicates user input, the search application 312 can reference the result object 132 used to generate a displayed search result 132′ that is receiving user input to identify result objects 132 of other functionally similar displayed search results 132′.

After identifying functionally similar displayed search results 132′, the search application 312 can replicate input received in one of the functionally similar displayed search results 132′a into the other functionally similar displayed search results 132′b. The search application 312 can monitor the user input received in the values of the displayed search results 132′. Each time the user enters a value into an input element of a displayed search result 132′a, the search application 312 can read in the entered value and can replicate the value in the input elements of other functionally similar displayed search results 132′b.

In some implementations, the search application 312 replicates the user input by transmitting the value input entered by the user into a particular input element of a displayed search result 132′ as well as an identifier of the input element that received the value (e.g., the parameter type corresponding to the input element) to the search engine 200. The search engine 200 responds with instructions to replicate the user input in the other functionally similar displayed search results 132′. For instance, the instruction can identify the result object IDs of the other functionally similar displayed search results 132′, an identifier(s) of the input element(s) in which the value is to be replicated, and the value(s) to insert in the input element(s). The search application 312 receives the instruction and updates the identified displayed search results 132′ in accordance with the instruction. A value that is transmitted to the search engine 200 may be transmitted for other purposes as well, such as autocomplete or autosuggest. For example, the user types the value “SFO” into a text input element (e.g., text input element 704a of FIG. 7C) and the search engine 200 completes the value that is inputted into the text input element as “SFO-San Francisco Intl.”). In such a scenario, the value of “SFO-San Francisco Intl.” can be replicated in a text input element (e.g., text input element 704b of FIG. 7C) of the functionally similar displayed search results 132′.

In other implementations, the search application 312 replicates the user input across functionally similar displayed search results without additional communication with the search engine 200. In these implementations, the search application 312 monitors the user input entered into the displayed search results 132′. When the user enters a value into an input element of a displayed search result 132′a having other functionally similar displayed search results 132′b, the search application 312 reads in the value entered by the user and the parameter type received by the input element receiving the user input, which may be defined in the input binding of the displayed search result 132′a. The search application 312 then identifies an input element of a functionally similar displayed search result 132′b that receives the same parameter type from the input binding of the functionally similar displayed search result 132′b and inserts the value in the identified input element 132′b. For example, in FIG. 7C, the search application may read the value “SFO-San Francisco Intl.” from the first text input element 704a and a parameter type of “departure_airport_code.” The search application 312 identifies the first text input element 704b of the Travel Buddy displayed search result 132′b based on the parameter type of “departure_airport_code” and inserts the value “SFO-San Francisco Intl.” into the identified text input element 704b. The search application 312 may replicate in other suitable manners as well.

A user may select a user selectable link 132′ by, for example, pressing on a selection element 714a, 714b. In the case the user selects a user selectable link 132′ with input elements 134, the search application 312 can generate an access mechanism using the parameter values inputted by the user (either explicitly or by way of replication). The search application 312 can generate the access mechanism in the manner described above. The search application 312 can treat replicated input the same as input explicitly entered by the user. The search application 312 can then access the state of the application using the generated access mechanism.

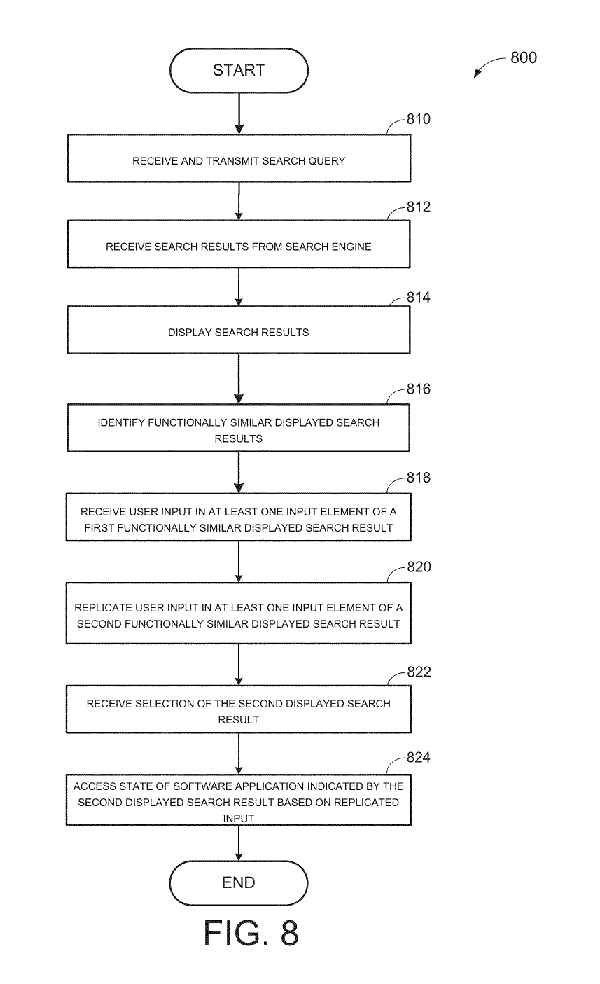

FIG. 8 illustrates an example set of operations of a method 1000 for replicating user input across displayed search results 132′. For purposes of explanation, the method 800 is described with respect to the search application 312 of FIG. 3. The method 800, however, may be executed by any other suitable application that displays displayed search results 132′ that receive user input.

At operation 810, the search application 312 receives a search query 102 from a user via a user interface device 330 of the user device 300 and transmits the search query 102 to a search engine 200. The search application 312 may also transmit one or more query parameters 104 to the search engine 200 with the search query 102.

At operation 812, the search application 312 receives search results 130 that are responsive to the search query 102 from the search engine 200. The search results 130 contain a plurality of result objects 132. The result objects 132 include a first result object 132 corresponding to a first displayed search result 132′a and a second result object 132 corresponding to a second displayed search result 132′b. At operation 814, the search application 312 displays the displayed search result 130′. For each result object 132 contained in the search results 130, the search application 312 can generate a displayed search result 132′ based on the result object 132 and can output the displayed search result 132′ to the SERP, which is displayed via the user interface device 330 of the user device 300. In doing so, the search application 312 generates the first displayed search result 132′a based on the first result object 132 and the second displayed search result 132′b based on the second result object 132.

At operation 816, the search application 312 identifies functionally similar displayed search results 132′. As previously discussed, the search application 312 can read a function tag in each result object 132 to identify functionally similar displayed search results 132′. In other implementations, the search application 312 can analyze the parameter types of the input elements displayed in each displayed search result 132′ to identify the functionally similar displayed search results 132′. Alternatively, the search engine 200 may include, in each result object 132, the result object IDs of other displayed search results 132′ that are functionally similar to the displayed search result 132′ generated based on the result object 132. For purposes of explanation it is assumed that the first displayed search result 132′a and the second displayed search result 132′b are functionally similar.

At operation 818, the search application 312 receives user input into at least one input element of the first displayed search result 132′. The search application 312 monitors the displayed search results 132′. When the user enters input into one of the input elements, the search application 312 updates the displayed search result 132′ to indicate the user input. For example, a user may enter text via a touchscreen keyboard displayed via the user interface device 330. As the user enters text, the search application 312 can update a selected input text input element with the text being entered by the user. As the user enters the user input, the search application 312 reads in the values entered into the input element.

At operation 820, the search application 312 replicates the user input provided to the first displayed search result 132′a into at least one input element of the second displayed search result 132′b. The search application 312 can replicate user input into functionally displayed search results 132′ automatically or in response to an instruction from a user (e.g., selection of a replicate selection element 702). In some implementations, the search application 312 transmits a result object ID corresponding to the second displayed search result 132′b, one or more values entered by the user into one or more respective input elements of the first displayed search result 132′a, and one or more parameter types associated with the one or more input elements that received the one or more values. In these implementations, the search engine 200 returns an instruction to the search application 312 that indicates one or more input elements of second displayed search result 132′b and one or more respective values with which to populate the one or more input elements with. The respective values are replicated from the one or more values input into the first displayed search result 132′a. In other implementations, the search application 312 matches the input elements of the second displayed search result 132′b to the input elements of the first displayed search result 132′a based on parameter types associated with the respective input elements. For instance, the search application 312 may utilize the respective input bindings to match the input elements of the respective displayed search results 132′. The search application 312 then inputs the values read from the one or more input elements of the first displayed search result 132′a into one or more matching input elements of the second displayed search result 132′b.

At operation 822, the search application 312 receives a user selection of the second displayed search result 132′b. At operation 1024, the search application 312 accesses a state of the software application indicated by the search displayed search result 132′b based on the replicated input. In particular, the search application 312 can read in the values from input elements of the second displayed search result 132′b and can determine an access mechanism based thereon. For example, if a native application edition of the software application indicated by the second displayed search result 132′ is installed on the user device 300, the search application 312 can generate an application access mechanism based on the received input. In some implementations, the search application 312 transmits the values input into the second displayed search result 132′ to the search engine 200. The search application 312 can also transmit an identifier of the edition of the software application that is installed on the user device 300. In response to the search engine 200 returns an application access mechanism corresponding to the received user input. In other implementations, the search application 312 references access mechanism data that defines templates for generating the application access mechanism. In these implementations, the search application 312 generates the application access mechanism based on the templates and the values read from the second displayed search result 132′b. The search application 312 then instructs the operating system to launch the native application edition indicated by the application access mechanism and to set the state of the native application edition based on the application access mechanism. For example, the search application 312 can pass the application access mechanism to the operating system, whereby the operating system is configured to handle the application access mechanism.

The method 800 of FIG. 8 is provided for example only. Variations of the method 1000 are contemplated and are within the scope of the disclosure. For example, in some implementations, the search application 312 may be configured to identify functionally relevant search results in addition to or alternative to functionally similar search results. A functionally relevant search result is a search result that performs a function that is relevant to another function. For example, a search result that corresponds to making a car or hotel reservation may be functionally relevant to a search result for making a flight reservation, as the user may wish to make a hotel reservation and/or a card reservation after making a flight reservation. Thus, the search application 312 can replicate user input across functionally relevant search results. In these implementations, the search application 312 replicates the input to the same type of input elements, as was described above. In the example of the car or hotel reservation, the search application 312 can replicate the departure and return dates to the check-in and check-out dates of a hotel reservation search result or a pick-up and return date of a car rental search result. Further, the search application can replicate the arrival city in the city field of the hotel reservation search result or the car rental search result. The search application 312 can identify functionally relevant search results based on the input elements defined in the search results and/or using a lookup table that relates functionally similar search results.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus,” “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
transmitting, by a processing device of a user device, a search query to a search engine;
receiving, by the processing device, search results in response to the search query, the search results including a first result object corresponding to a first displayed search result and a second result object corresponding to a second displayed search result, the first displayed search result corresponding to a first software application and the second displayed search result corresponding to a second software application;
generating, by the processing device, the first displayed search result based on the first result object, the first displayed search result being displayed in a graphical user interface via a user interface of the user device and including one or more first input elements that receive user input;
generating, by the processing device, the second displayed search result based on the second result object, the second displayed search result being displayed in the graphical user interface via the user interface of the user device and including one or more second input elements that receive user input;
receiving, by the processing device, a user input in at least one of the one or more the first input elements via the user interface;
replicating, by the processing device, the user input in at least one of the one or more second input elements;
receiving, by the processing device, a selection of the second displayed search result by the user via the user interface;
determining, by the processing device, an access mechanism to access a state of the second software application indicated by the second displayed search result based on the replicated user input; and
launching, by the processing device, an edition of the second software application using the access mechanism.

2. The method of claim 1, wherein replicating the user input includes:
determining that the first displayed search result is functionally similar to the second displayed search result;
for each of the at least one first input elements that received user input,
identifying whether the second displayed search result includes a corresponding second input element that receives the same parameter type as the first input element; and
when the second displayed search result includes the corresponding second input element:
reading user input from the first input element; and
inserting the read user input into the corresponding second input element.

3. The method of claim 2, wherein determining the first displayed search result is functionally similar to the second displayed search result includes:
determining a first function of the first software application implicated by the first displayed search result;
determining a second function of the second software application implicated by the second search result; and
determining that the first displayed search result and the second displayed search result are functionally similar when the first function and the second function match.

4. The method of claim 1, wherein the access mechanism is an application access mechanism and launching the edition of the second software application includes launching a native application edition of the second software application and setting the state of the native application edition to the state indicated by the application access mechanism.

5. The method of claim 1, wherein determining the access mechanism includes:
transmitting, by the processing device, a request to the search engine for the access mechanism, the request including the replicated input; and
receiving, by the processing device, the access mechanism from the search engine.

6. The method of claim 1, wherein determining the access mechanism includes generating the access mechanism based on a template contained in the second result object and the replicated input.

7. The method of claim 1, wherein the method includes:
generating, by the processing device, a third displayed search result based on a third result object contained in the search results, the third displayed search result being displayed in the graphical user interface via the user interface and including one or more third input elements that receive user input;
determining whether the third displayed search result is functionally similar to the first displayed search result; and
when the third displayed search result is functionally similar to the first displayed search result, replicating, by the processing device, the user input in at least one of the one or more third input elements.

8. The method of claim 1, wherein replicating the user input includes receiving a user selection of a replicate selection element displayed in the graphical user interface, wherein replicating the user input is performed in response to the selection of the replicate selection element.

9. The method of claim 1, wherein replicating the user input is performed automatically in response to determining the first displayed search result and the second displayed search result are functionally similar and receiving the user input.

10. The method of claim 1, wherein replicating the user input includes:
transmitting a request to the search engine, the request including at least one value and at least one respective parameter types corresponding to the at least one first input elements that received the at least one value;
receiving an instruction from the search engine, the instruction indicating the at least one second input element and at least one respective value to input in the at least one second input element; and
inserting the at least one value in the respective at least one second input element.

11. A user device comprising:
a user interface;
a storage device;
a network interface device;
a processing device, the processing device executing computer-readable instructions that when executed cause the processing device to:
transmit a search query to a search engine;
receive search results in response to the search query, the search results including a first result object corresponding to a first displayed search result and a second result object corresponding to a second displayed search result, the first displayed search result corresponding to a first software application and the second displayed search result corresponding to a second software application;
generate the first displayed search result based on the first result object, the first displayed search result being displayed in a graphical user interface via the user interface and including one or more first input elements that receive user input;
generate the second displayed search result based on the second result object, the second displayed search result being displayed in the graphical user interface via the user interface and including one or more second input elements that receive user input;
receive user input in at least one of the one or more the first input elements via the user interface;
replicate the user input in at least one of the one or more second input elements;
receive a selection of the second displayed search result by the user via the user interface;
determine an access mechanism to access a state of the second software application indicated by the second displayed search result based on the replicated user input; and
launch an edition of the second software application using the access mechanism.

12. The user device of claim 11, wherein replicating the user input includes:
determining that the first displayed search result is functionally similar to the second displayed search result;
for each of the at least one first input elements that received user input,
identifying whether the second displayed search result includes a corresponding second input element that receives the same parameter type as the first input element; and
when the second displayed search result includes the corresponding second input element:
reading user input from the first input element, and
inserting the read user input into the corresponding second input element.

13. The user device of claim 12, wherein determining the first displayed search result is functionally similar to the second displayed search result includes:
determining a first function of the first software application implicated by the first displayed search result;
determining a second function of the second software application implicated by the second search result; and
determining that the first displayed search result and the second displayed search result are functionally similar when the first function and the second function match.

14. The user device of claim 11, wherein the access mechanism is an application access mechanism and launching the edition of the second software application includes launching a native application edition of the second software application and setting the state of the native application edition to the state indicated by the application access mechanism.

15. The user device of claim 11, wherein determining the access mechanism includes:
transmitting, by the processing device, a request to the search engine for the access mechanism, the request including the replicated input; and
receiving, by the processing device, the access mechanism from the search engine.

16. The user device of claim 11, wherein determining the access mechanism includes generating the access mechanism based on a template contained in the second result object and the replicated input.

17. The user device of claim 11, wherein the computer readable instructions further cause the processing device to:
generate a third displayed search result based on a third result object contained in the search results, the third displayed search result being displayed in the graphical user interface via the user interface and including one or more third input elements that receive user input;
determine whether the third displayed search result is functionally similar to the first displayed search result; and
when the third displayed search result is functionally similar to the first displayed search result, replicate the user input in at least one of the one or more third input elements.

18. The user device of claim 11, wherein replicating the user input includes receiving a user selection of a replicate selection element displayed in the graphical user interface, wherein replicating the user input is performed in response to the selection of the replicate selection element.

19. The user device of claim 11, wherein replicating the user input is performed automatically in response to determining the first displayed search result and the second displayed search result are functionally similar and receiving the user input.

20. The user device of claim 11, wherein replicating the user input includes:
transmitting a request to the search engine, the request including at least one value and at least one respective parameter types corresponding to the at least one first input elements that received the at least one value;
receiving an instruction from the search engine, the instruction indicating the at least one second input element and at least one respective value to input in the at least one second input element; and
inserting the at least one value in the respective at least one second input element.

21. A method comprising:
receiving, by a processing device, a search query from a user device,
generating, by the processing device, search results based on the search query, the search results including a first result object corresponding to a first displayed search result and a second result object corresponding to a second displayed search result, the first displayed search result corresponding to a first software application and, when rendered by the user device, including one or more first input elements that receive user input and the second displayed search result corresponding to a second software application and, when rendered by the user device, including one or more second input elements that receive user input;
receiving, by the processing device, an instruction from the user device indicating at least one input value input into at least one of the first input elements of the first displayed search result;
determining, by the processing device, an instruction based on the input data indicating at least one replicated value to input into at least one of the second input elements of the second displayed search result based on the at least one input value, and
transmitting, by the processing device, the instruction to the user device, whereby the user device inserts the at least one replicated value in at least one of the second input elements.
